(19) United States
(12) Patent Application Publication
(10) Pub. No.: US 2006/0259524 A1
(43) Pub. Date: Nov. 16, 2006

(54) Systems and methods for document project management, conversion, and filing

(76) Inventor: D. Troy Horton, Sandy, UT (US)

Correspondence Address: STOEL RIVES LLP - SLC, 201 SOUTH MAIN STREET, ONE UTAH CENTER, SALT LAKE CITY, UT, 84111, US

(21) Appl. No.: 11/486,600

(22) Filed: Jul. 14, 2006

Related U.S. Application Data
(63) Continuation-in-part of application No. 10/802,258, filed on Mar. 17, 2004.
(60) Provisional application No. 60/455,148, filed on Mar. 17, 2003.

(51) Int. Cl. G06F 17/30

(52) U.S. Cl. 707/201

(57) ABSTRACT

A document management system includes means for receiving a document through a network and converting the document to a format that is compatible with an online electronic filing system. In one embodiment, the format is compliant with the Security Exchange Commission's EDGAR database system. The system can split the document into a plurality of sub-documents that can be assigned to different editors. Thus, the editors can work in parallel with one another to prepare the document for filing. After the editors have made revisions, if any, to their respective sub-documents, the system merges the sub-documents into a single EDGAR-compliant document for submission to the EDGAR system.

### CROSS-REFERENCE TO RELATED APPLICATIONS

This application is a continuation-in-part of U.S. patent application Ser. No. 10/802,258, filed Mar. 17, 2004, which claims the benefit under 35 U.S.C. § 119(e) of U.S. Provisional Application No. 60/455,148, filed Mar. 17, 2003, both of which are hereby incorporated by reference herein in their entirety.

### TECHNICAL FIELD

The present disclosure relates generally to document preparation and document project management. More specifically, the present disclosure relates to systems and methods for converting documents to acceptable formats for electronic filing.

### BACKGROUND INFORMATION

During large document drafting and preparation projects, a document project manager typically assigns document sections and sub-sections to document team members. These team members draft and revise document sections. For each document section there is typically more than one person proposing document drafts and revisions. The tools currently available for online document preparation do not support the simultaneous viewing of proposed drafts and revisions from multiple sources.

Another problem with document management is that each person working on a document preparation team makes multiple drafts which get combined into multiple versions. Tracking the multiple drafts and versions that come from different team members requires significant time and attention.

Yet another problem is found when using typical online tools for document management. Document preparation team members must manually post document drafts and revisions into a central document repository. This approach does not adequately enable team-level security (for example, during a merger and acquisition document project, it is sometimes desirable for separate teams to not view each others' documents) or local storage of documents.

### BRIEF DESCRIPTION OF THE DRAWINGS

FIG. 1 is a block diagram of a system for managing, converting, and electronically filing documents according to one embodiment;

FIG. 2 is a block diagram of a document management portal according to one embodiment;

FIG. 3 graphically illustrates a file hierarchy according to one embodiment;

FIG. 4 illustrates an example user interface for providing version control for documents and other files according to one embodiment;

FIG. 5 is an example user interface for simultaneous viewing of proposed document drafts and revisions from multiple reviewers and sources according to one embodiment;

FIGS. 6A-6B illustrate example user interfaces for simultaneous viewing of proposed document drafts and revisions according to one embodiment;

FIG. 7 illustrates an example user interface for simultaneous viewing of proposed document drafts and revisions according to another embodiment;

FIG. 8 is a block diagram of a document collaboration and management system according to one embodiment;

FIGS. 9A-9B are flow charts of a process for aggregating, converting, splitting and distributing work products, merging and submitting completed documents to an EDGAR-compliant format according to one embodiment;

FIGS. 10A-10E are example user interfaces for converting documents for submission to the Securities Exchange Commission (SEC) according to one embodiment;

FIG. 11 is an example user interface for merging split HTML files according to one embodiment;

FIGS. 12A-12R are example user interfaces for an online work request system according to one embodiment; and

FIGS. 13A-13I are example user interfaces for an online distribution system according to one embodiment.

### DETAILED DESCRIPTION

In the following description, reference is made to the accompanying drawings, which form a part hereof, and which show, by way of illustration, specific embodiments or processes. Where possible, the same reference numbers are used throughout the drawings to refer to the same or like components. In some instances, numerous specific details of programming, software modules, user selections, network transactions, database queries, database structures, and the like, are provided for a thorough understanding of the embodiments. However, those skilled in the art will recognize that the embodiments described herein can be practiced without one or more of the specific details, or with other methods, components, and materials.

In some cases, well-known structures, materials, or operations are not shown or described in detail in order to avoid obscuring aspects of the embodiments described herein. Furthermore, the described features, structures, or characteristics may be combined in any suitable manner in one or more embodiments.

I. System Overview

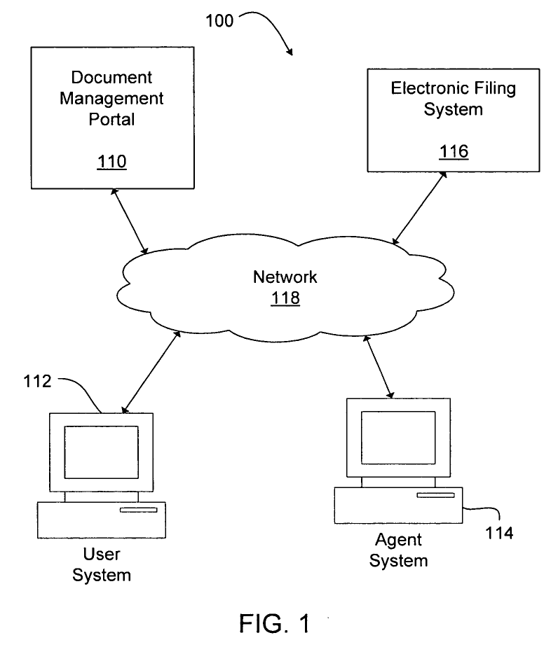

FIG. 1 is a block diagram of a system 100 for managing, converting, and electronically filing documents according to one embodiment. The system 100 is configured to process and transfer information between entities involved in producing, editing, managing, converting, printing, distributing, storing, and electronically filing financial documents and other documents. The system 100 includes a document management portal 110, a user system 112, an agent system 114, and an electronic filing system 116 connected through a network 118. The network 118 may include, for example, a local area network (LAN), a wide area network (WAN), a Public Switched Telephone Network (PSTN), a cable television (CATV) network, the Internet, or other connection services and network variations such as the world wide web, the public internet, a private internet, a private computer network, a secure internet, a private network, a public network, a value-added network, combinations of the foregoing, or the like, including, but not limited to, existing wired and wireless distribution systems in any form currently employed or employed in the future. However, those skilled in the art will recognize that the embodiments described herein can be practiced without one or more of the specific details, or with other methods, components, and materials.

The document management portal 110, the user system 112, the agent system 114, and the electronic filing system 116 may include, for example, computers comprising any microprocessor controlled device that permits access to the network 118, including terminal devices, such as personal computers, workstations, servers, mini-computers, hand-held computers, main-frame computers, laptop computers, mobile computers, set top boxes for televisions, combinations thereof, or the like. The computers may further include input devices such as a keyboard, voice recognition, optical character recognition (OCR), microphone, other document production/management systems or a mouse, and output devices such as a computer screen, a printer, all known electronic formats or a speaker.

The system 100 allows a user such as working group member (WGM) with access to the user system 112 to manage the creation, review, editing, completion, electronic filing, production, and distribution of financial and other documents through the document management portal 110. A user such as an administrator or project leader may authorize one or more WGM to access and/or edit documents associated with a particular project on the document management portal 110.

The system 100 enables the processes described herein to be conducted on-line or enables the WGM to check-out a downloadable version of a document. Thus, the WGM can work off-line from, for example, a laptop if unable to access the Internet, or other public or private networks, for a period of time. Upon return to Internet access, the WGM can then check-in the document for further processing or review by other group members. Thus, groups of users can collaborate on projects to create and edit documents with little or no disruption.

In one embodiment, the user system 112 creates financial or other documents for submission to the electronic filing system 116. The electronic filing system 116 may be operated by a government agency. In certain example embodiments described herein, the electronic filing system 116 comprises the Electronic Data Gathering, Analysis and Retrieval (EDGAR) system provided by the Securities Exchange Commission (SEC) for SEC filings. However, an artisan will recognize from the disclosure herein that other electronic filing systems could also be used. For example, the document management portal 110 may be used to electronically file tax returns with the Internal Revenue Service or to electronically file documents to satisfy other government regulatory requirements (e.g., HIPPA, FDA).

The SEC generally requires publicly traded companies to file disclosure documents electronically through the EDGAR system. This SEC rule generally applies to all quarterly, annual and special filings. Further, currently, the SEC rules generally require electronic filings through the EDGAR system to follow a prescribed HTML or ASCII format. Future formats, such as XBRL and other derivative formats will also be supported as required by the submission portals. Thus, as described in greater detail below, the document management portal 110 converts documents received from the user system 112 from their existing format(s) to an EDGAR-compatible format, according to one embodiment, and submits the converted document to the EDGAR system. The document management portal 110 performs test SEC filings and, upon the user's approval, actual SEC filings through the EDGAR system.

In addition, or in other embodiments, the agent system 114 may be used to prepare and file documents through the electronic filing system 116. The agent system 114 may be used by, for example, a financial printing service capable of preparing, editing, printing, distributing, and filing financial and other documents on behalf of a user of the user system 112. The agent system 114 may use the document management portal, for example, to edit, print and distribute legal and financial reports to current and prospective stockholders associated with the user system 112. The agent system may also create and submit documents without human intervention from existing data stores and repositories.

The agent system 114 may also use the document management portal 110 to electronically file SEC filings, for example, through the EDGAR system. Preparing and filing SEC filings through the EDGAR system may be legally and technically complex. Thus, many users prefer to use specialized filing agents, such as certain financial printing service providers, to help prepare and file the SEC filings through the EDGAR system.

In one embodiment described in detail below, a user of the agent system 114 uses the document management portal 110 to split a document into two or more sub-documents that may be edited and converted to an EDGAR-compatible format by two or more users of the agent system 114. Thus, portions of large documents can be processed in parallel by different users. The split portions can then be merged into a single document for electronic filing through the EDGAR system.

II. Document Management Portal

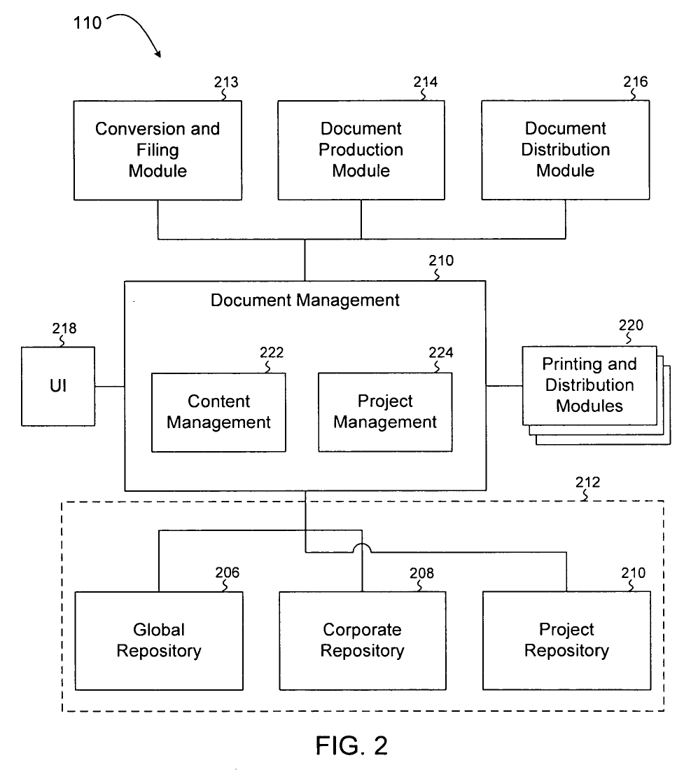

FIG. 2 is a block diagram of the document management portal 110 according to one embodiment. The document management portal 110 includes a document management module 210 in communication with a document repository 212, a conversion and filing module 213, a document production module 214, a document distribution module 216, a user interface (UI) 218, and printing and distribution modules 220.

The document management module 210 includes a content management sub-module 222 and a project management sub-module 224. The content management sub-module 222 provides a user with the ability to find a source document (or initial document) in the document repository 212 and convert it into a custom document template. In one embodiment, the custom document template comprises a standard XML-based format. Document translators (not shown) convert the documents the documents in the document repository 212 to and from conventional word processing and/or spreadsheet applications (e.g., Word, WordPerfect, Lotus Notes, Excel, HTML). The document translators allow users to use their own various, existing word processing tools while maintaining document formats, style guides, and templates.

The content management sub-module 222 also provides the user with the ability to draft, review, edit, proofread, store, and retrieve documents. The user can also apply notation to a given section being modified by a specific WGM, which enables the user to post comments to defend why the user's changes should be incorporated and not modified by up-line reviewers. The notes are seen only during the drafting process for creation history purposes and are not incorporated into a final typeset or final EDGAR document, which are respectively printed or filed with the SEC.

The content management sub-module 222 also provides a flexible, configurable workflow engine with which authorized users can define and manage review procedures and responsibilities. For example, a project manager (or authorized assistant) can configure the WGM workflow so that a draft being worked on by a given team member can be reviewed by a team leader before the system notifies the up-line manager (another team leader or the project manager) to review and approve, modify or reject edits before the final draft's cycle changes are applied to the core document and document version updated. Or, as another example, the workflow can be configured so that drafts are automatically included in a document version then reviewed by up-line team leaders or project managers.

The project management sub-module 224 provides a user with the ability to create and administer project teams, assign project tasks and timelines, track tasks and responsibilities, and generate task and project completion reports and alerts. The project management sub-module 224 also provides the user with the ability to track the number of pages converted from an original document to a specific system typeset and/or EDGAR final document(s) for client billing purposes (e.g., this may include the number of base document pages rather than the total number of pages including all revision pages). Project accounting allows professional firms to track, compile, and report billing information.

The project management sub-module 224 also provides the user with the ability to communicate, at a minimum via email or chat rooms, with limited WGMs within a team or by all WGMs assigned to work on a given project. In one embodiment a product roadmap includes communication using instant messaging and web conferencing. The project management sub-module 224 also provides the user with the ability to create sub-working teams with their own secure document repositories.

In one embodiment, the content management sub-module 222 uses unique functionality for document drafting, review, editing, proofreading, storage, and retrieval. Such unique functionality may include, for example, the ability for a project manager to divide or split a document into subsections that can be worked on separately and independently from a main document by project team members. As discussed in detail below, a document may be split into sub-documents that can be converted, for example, into individual EDGAR-compliant documents. The individual EDGAR-compliant documents can then be merged and filed as a single document.

A. Document Control

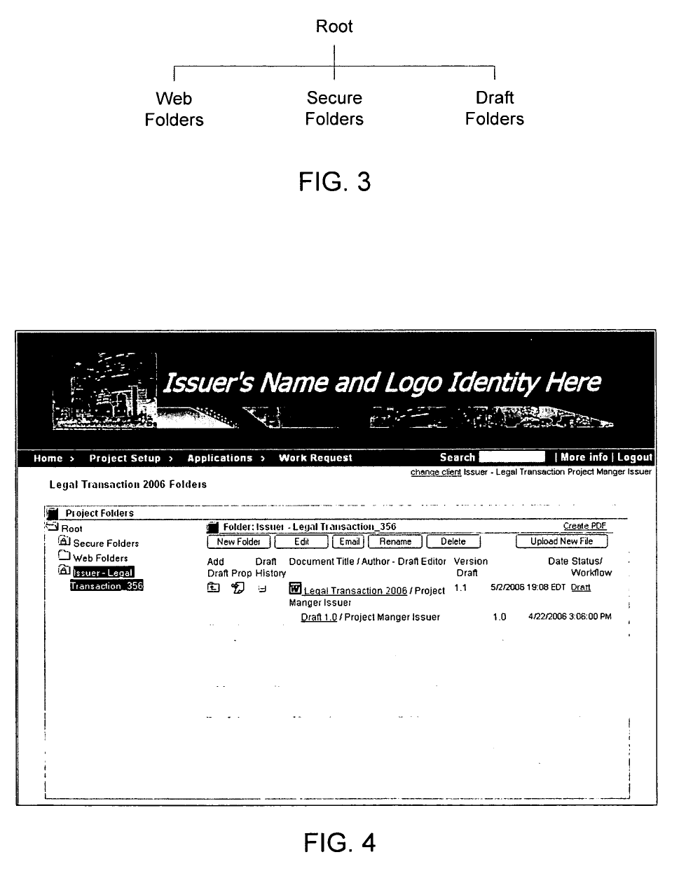

In one embodiment, the content management sub-module 222 supports three types of file system folders. For example, FIG. 3 graphically illustrates a file hierarchy 300 according to one embodiment. The file hierarchy 300 includes a root directory 310 for organizing document files. In one embodiment, the root directory 310 has sub-directories or sub-folders including web folders 312, secure folders 314, and draft folders 316.

The web folders 312 are for documents and other files (such as graphics) that a user may want to access by hyperlink. For example, the web folders 312 may include images that are to be viewed in web pages or portal pages, or documents that the user want to distribute with a hyperlink in an email message. All files in the web folders 312 can be opened by hyperlinks. However, in one embodiment, users cannot browse to files in folders that they are not permitted to view.

The secure folders 314 are for files and documents that a user may want to secure. Thus, the user can limit access to files and documents in the secure folders 314 to WGMs who have signed in to the system. In one embodiment, the files and documents in the secure documents folders 314 cannot be viewed by normal hyperlinks or URLs.

The draft folders 316 are also are secure and provide version control. The draft folders 316 are used for documents that undergo revisions and updates. The draft folders 316 also provide for editors to upload a draft of a document, while authors can upload new documents and new versions. Files are identified by version number and draft number. For example, a document titled “myDocument 3.2” is a third version 3, second draft 2 (within the third version) of an original file.

As explained above, a problem with document management is that each person working on a document preparation team makes multiple drafts that get combined into multiple versions. Thus, in one embodiment, the content management sub-module 222 may manually or automatically provide one or both of a draft number and a version number. For example, person A's multiple drafts are tracked by that person's draft numbering system. Person A then selects which draft will be submitted for inclusion in the document.

When a document project manager or a document owner selects which drafts to include in the next version of the document, the content management sub-module 110 assigns a new version number to the document. Using this system, previous drafts and versions are easily accessible and the document is built without confusion or rework.

FIG. 4 illustrates an example user interface 400 for providing version control for documents and other files according to one embodiment. The user interface 400 includes links to a root directory 310, secure folders 314, web folders 312, and a draft folder called “Issuer-Legal Transaction_356.” The user interface 400 also shows drafts 1.0 and 1.1 of a document 412 within the draft folder 410. The document 412 is managed by version control. Thus, multiple copies are saved to the draft folder 410. Each copy of document 412 is saved at a version level (e.g., version 1) and a draft level (e.g., draft levels 0.0 and 0.1). In one embodiment, the content management sub-module automatically assigns version and draft numbers.

A user can open the most current copy (e.g., 1.1) of the document 412. In one embodiment, previous versions and drafts can also be seen and downloaded. A user that uploaded or edited each file is displayed as an author/draft editor, and a date and time the document 412 was uploaded or edited is also displayed.

In one embodiment, the user interface 400 also includes a new folder button 414, an edit button 416, an email button 418, a rename button 420, a delete button 422, and a upload new file button 424. The new folder button 414 creates a new folder if the user is attached to the root directory 310 or a sub-folder of a currently selected folder (e.g., the draft folder 410). The edit button 416 edits properties of the currently selected folder. The email button 418 sets up an email notification used when a user uploads documents to the folder. The rename button 420 renames the currently selected folder. The delete button 422 deletes the currently selected folder. The upload new file button 424 sends a selected file to the web folder 312 and is usable by users authorized to upload files.

The user interface 400 also includes a create PDF hyperlink 426. The create PDF hyperlink 426 opens a new user interface that allows the user to select one or more documents to be converted to a single PDF file. Thus, final versions of documents (or portions of documents) can be merged into a single PDF file (or any electronic format), for example, for submission to a printing service and/or electronic distribution.

B. Document Compare and Merge

In one embodiment, the content management sub-module 222 includes a review feature that allows a user to compare and merge different versions and drafts of documents. Thus, a reviewer (e.g., team leaders or project managers) can simultaneously view multiple drafts submitted by one or more assigned WGMs, find and highlight the differences among and between drafts submitted by different WGMs, and select (without cutting and pasting) a draft to include in the next document version. The reviewer can also revise and select a draft, or create and additional draft for their own use.

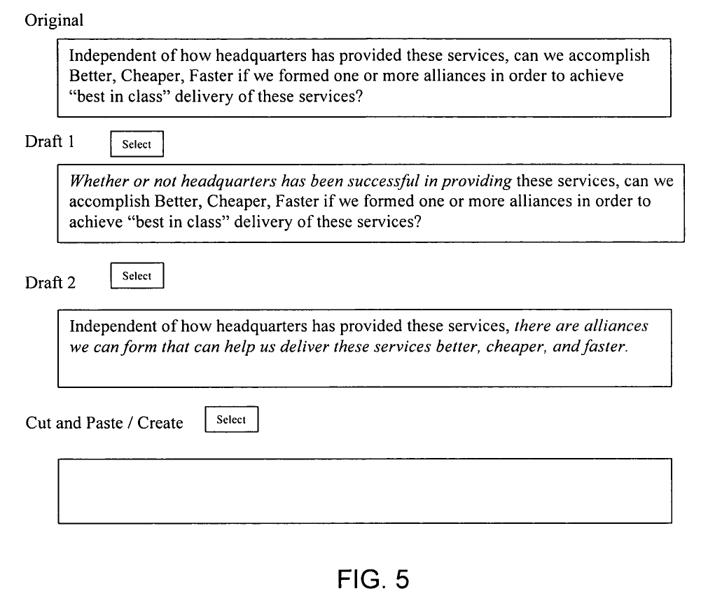

For example, FIG. 5 illustrates an example user interface for simultaneous viewing of proposed document drafts and revisions from multiple reviewers and sources according to one embodiment. Using this functionality, a document team member can perform a simultaneous, side-by-side comparison of the differences being suggested by multiple drafters of a document section.

In one embodiment, the differences are highlighted in order to make it easy to find differences. Each separate proposed draft or revision is segmented so that the document team member can select one of the proposed drafts or revisions. For example, FIG. 5 shows a first window 510 for an original portion of a document, a second window 512 for a first modified draft of the portion of the document, and a third window 514 for a second modified draft of the portion of the document. In one embodiment, the team member can also cut and paste segments from more than one draft or revision (e.g., from one or more of the windows 510, 512, 514) into a final version window 516. The team member can also transfer segments from more than one draft or revision. Finally, the team member can also create his or her own version in the final version window 516.

In one embodiment, the content management sub-module 222 shown in FIG. 2 includes a reviewer function that allows a document reviewer to start at the beginning of a document and to move through changes and comments made by document editors, one portion at a time, accepting some changes, rejecting other changes, and accepting other changes with modification. The process continues until all of the desired changes and comments have been processed. The document is then saved at a new version level. A history of all comments and suggested changes is retained.

In one embodiment, the reviewer can compare and merge changes to one or more documents that are received in different formats. The formats may include, for example, Microsoft Word (e.g., versions 2000, XP, 2003 and/or 2007), WordPerfect, SUN's StarOffice, PDF, DocBook, and other conventional word processor and electronic formats. In one embodiment, such word processor formats are converted into an internal format. In one embodiment, the compare and merge application accepts as input various document formats, including documents with or without the source document's “track changes” feature enabled, and documents with “blackline” or “redlined” formatting.

For example, Blackline documents created with Documentum or InterWoven can be converted into the internal format before performing the compare. Blackline documents are a standard in the legal industry wherein changes from the previous version are underlined. A clear version (a new version without blackline) is also provided. The blacklining is compatible with industry standards, so that a lawyer using InterWoven, for example, would not have to re-process the document in their system.

Following edit or review, the document is converted from the internal format to the format of the source document so that the author can save the document and work on it locally using their word processor of choice. Thus, multiple versions and drafts of a document may be created and edited. A complete audit trail of changes and comments, from the initial file forward, are saved. As discussed below, several views of changes (for example, by editor or by date or by section) and comments are provided.

In one embodiment, a compare and merge application comprises a standard application programming interface (API) for integration with a variety of document management systems such as Documentum, I-Manage, Interwoven, and the like. The API provides access to source documents and saves the resulting edited document. The API may be exposed as a web service at a server. For example, the merge and compare application may be used with documents stored in a Documentum or an Interwoven document system.

In one embodiment, an edit function provides text editing functionality (e.g., such as that provided by Microsoft Word or other word processing programs) within a web browser. Thus, a user may open a document file from a web server, edit the document using a familiar word processor's toolbar, and save the document to a local computer/network, to the document management portal 110 (e.g., via http, SOAP, ftp, sftp, ssh, Web Services, WebDAV, or any other electronic network port, protocol or other data transport methodology), or both.

Each selected document (e.g., draft 2.3) is compared to a common base version (e.g. version 2.0). The compare process can be performed on multiple drafts (selected by the user) against a single base version. A change is identified as any change in content or any inserted comment. In one embodiment, changes in format are ignored. In another embodiment, the user has the option to include or exclude format changes during the compare process.

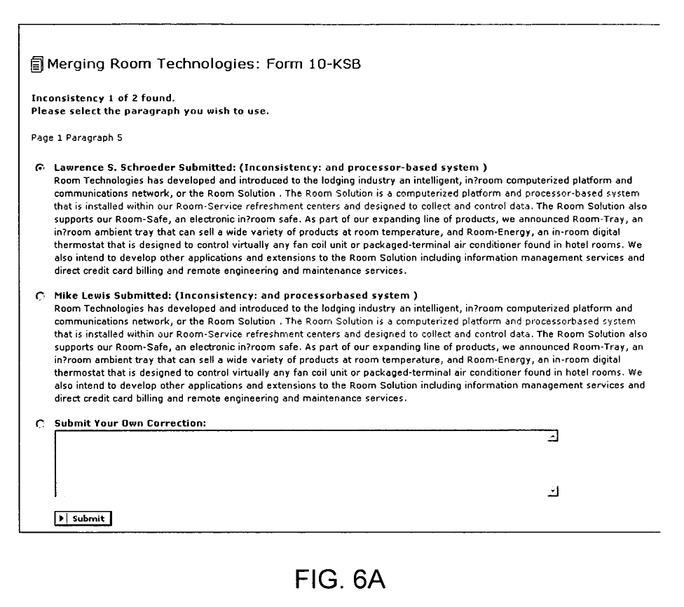

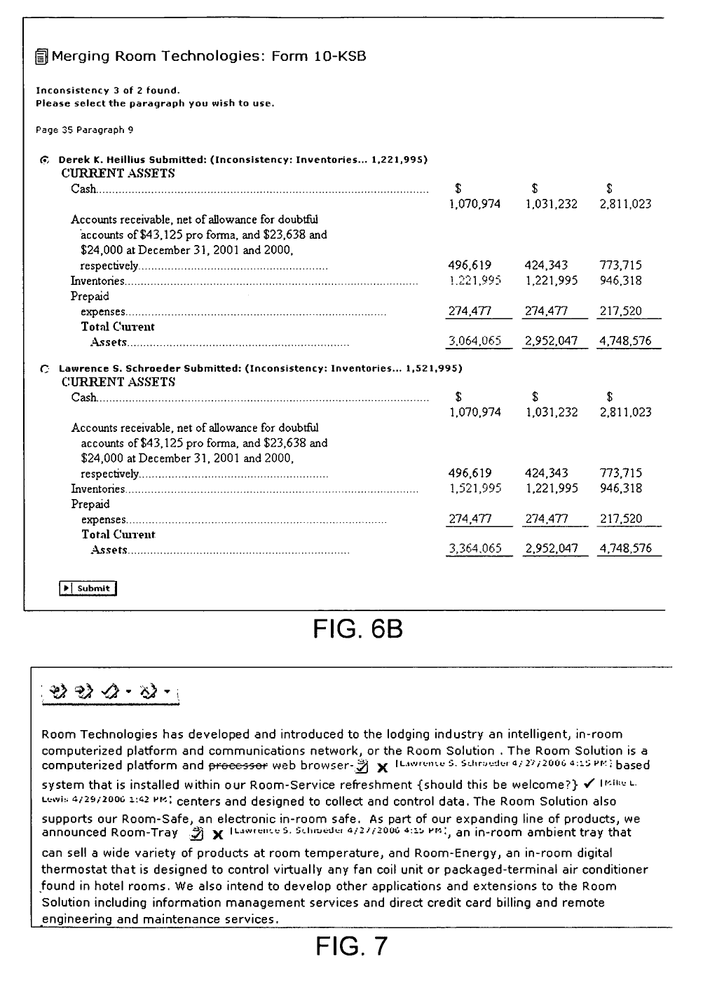

FIGS. 6A-6B illustrate example user interfaces 610, 612 for simultaneous viewing of proposed document drafts and revisions according to one embodiment. In this view, a user sees a section at a time (e.g., a paragraph or a table representing enough of the context of the change to provide clarity to the reader). For each user having a change to the selected paragraph, the entire paragraph is displayed. For each change-section (e.g., sentence, paragraph, or table), the change-section for each draft that has a change is displayed. In one embodiment, a show/hide button is displayed on each section. The editor's name is displayed for each draft.

FIG. 7 illustrates an example user interface 710 for simultaneous viewing of proposed document drafts and revisions according to another embodiment. In the user interface 710, changes are identified inline in the text. In one embodiment, each change displays the insertion/deletion in red (with strikethrough for deletion), followed by two icons and the name of the editor and timestamp of the change. By default, all changes and comments are displayed. At the document level, changes can be toggled on/off and Comments can be toggled on/off, to make it easy to read the document. To accept a change the user (e.g., a reviewer) simply clicks an accept change icon 712 and the result is displayed in standard format (e.g., the change is not visible) and moves to the next change. In one embodiment, although it will no longer be displayed, the editor's name is retained as the source of the change as well as all historical draft cycle content changed by all editors.

To reject a change the user clicks a reject change icon 714 that automatically discards the change. Again, a history of the discarded change is retained. However, the pre-change text is displayed in standard format and the change request is no longer visible. The user then moves to the next change. To edit a change, the user accepts the change and then makes an edit directly in the text. All inserts and changes by the user are added to the audit history as inserted by the user. The user can also cut and paste from other sources into the browser window. For example, a comment in a second draft may indicate a need to add a new section to the document. The user can search a local or remote document system, find an appropriate source, and insert it into the browser-window to satisfy the comment.

In one embodiment, comments are accepted from users and attached to a bookmark or placeholder tag in the document. Comments are never edited or deleted (except by the author of the comment) and are carried forward with the document to the final version. Team and/or project leads can view comments by author or, using icons in the document (i.e. at the bookmark or tag location), show or hide each comment.

The user can save the document to the service reponsitory or the user repository at any time. In one embodiment, an auto-save function saves the document after each change-section. In addition, a re-start function is provided so that if, for example, the Internet connection is lost the user can restart following the last change-section completed.

C. Multi-Tiered Document Repository

Returning again to FIG. 2, the document management module 210 manages documents uploaded to and downloaded from the document repository 212. Various types of document repositories may be provided. For example, as shown in FIG. 2, the document repository 212 may include a global document repository 206 that is accessible by all registered users of the document management portal 110. As described above, conventional approaches do not adequately enable team-level security, for example, during a merger and acquisition document project. Thus, the document management portal 110 provides several tiers of document repositories.

The first tier (tier 0) is the global document repository 206 and includes draft, generic financial documents and templates. The generalized documents and templates in the first tier are publicly available. Users can use the documents in the global repository 206 as a starting source by customizing the generalized documents.

The second tier (tier 1) is the corporate repository 208 and includes all documents (from multiple projects) for a particular user. The user may be a corporate (or other entity) customer of the document management portal 110 and/or the agent system 114. The corporate repository is secure and allows each customer to store and retrieve their documents in the document management portal 110. In one embodiment, the corporate repository 208 includes both active and archived documents. In one embodiment, only licensed employees of the particular customer can access the corporate repository 208.

The third tier (tier 2) is the project repository 210 and includes drafts and versions of project documents. A document owner, project manager, and/or team member can store and retrieve documents from the secure project repository. Team members can also synchronize centrally and locally stored versions of the documents. In one embodiment, in addition to the documents, drafts, and revisions, the project repository 210 also holds project communications and project plans for an active document project. In one embodiment, only named project team members can access documents in the project repository 210.

An artisan will recognize from the disclosure herein that other tiers can also be used. For example, in one embodiment, a fourth tier (tier 3) includes one or more sub-project repositories (not shown). The sub-project repositories are identical to the project document repository 210, but are accessible only to specified sub-project team members. Returning to the merger and acquisition example above, the document project manager can create sub-project teams that can access their Tier 2 repository 210 but cannot access each others' Tier 3 repositories. Using this functionality, the documents of the acquiring party are separate from the documents of the acquired party.

D. Architecture

In one implementation, the document management portal 110 is J2EE standards based, object-oriented, and uses an integration layer that utilizes Java messaging. Application modules may be built on and around a J2EE and JMS (or Web Services) integration layer. The applications can connect to and inter-operate with this integration layer. However, those of skill in the art will recognize that other technologies may be used. For instance, in another implementation, the document management portal 110 is based on the Microsoft Windows platform utilizing IIS, asp, NET and SQL. However, those skilled in the art will recognize that the embodiments described herein can be practiced without one or more of the specific details, or with other methods, components, and materials.”

Architecturally, the document management portal 110 operates in a secure, multiple-instance mode with multiple customers using their own secure, separate instance of the applications. Additionally, or in other embodiments, each customer may also create multiple instances of the applications to support multiple teams. The multiple-instance environment includes tier 0, tier 1, tier 2, and tier 3 instances. Tier 0 instances support the portal data and the global repository 206. Tier 1 customer instances include both licensed customers and project usage customers. The customers create corporate and/or organizational instances. The tier 2 and tier 3 project instances include instances for project teams (tier 2) and sub-project teams (tier 3). In another implementation, the document management portal operates in a secure, single-instance mode. Multiple customers typically share a single instance of the software applications, and multiple teams likewise share a single instance of the applications. Access control is provided at the Customer, Team, and User level to files and data.

In one embodiment, customers need only a client-side word processing application and Internet browser. The customers access the document management portal 110 via the Internet or corporate Intranet and do not need to download a client application (beyond what is necessary to satisfy security requirements) in order to use the applications discussed herein. However, if a customer needs to work on a project when not connected to the Internet, the customer may need to download and use a client-side application.

In one embodiment, customers can use the document management portal 110 in two modes. In a first mode, the document management portal 110 “hosts” applications for customers that want to use the applications on a project-by-project basis (e.g., an ASP or SaaS solution). For the customers that select the first mode, the document management portal 110 manages and stores project data in real time. In a second mode, the document management portal 110, including one or more of its applications, is installed in the production environment of its customers. For the customers that select the second mode, the document management portal 110 may perform periodic synchronization of project data with another implementation (e.g., an enterprise solution).

E. Document Collaboration and Management

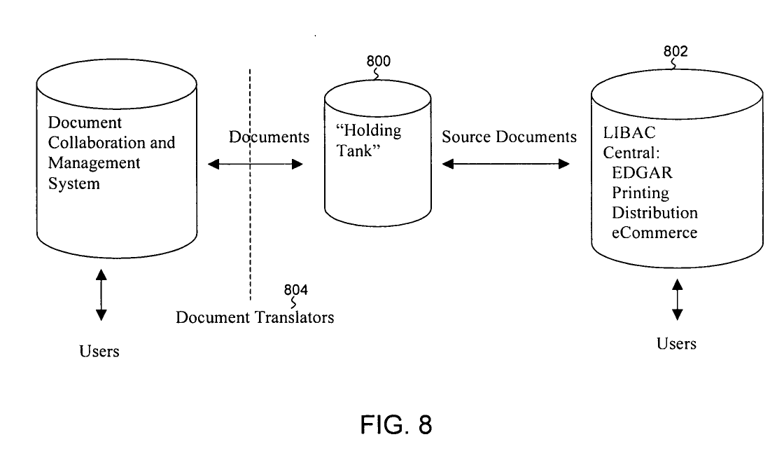

FIG. 8 is a block diagram of a document collaboration and management system according to one embodiment. In one embodiment, the document management portal 110 uses customized, existing technology for document collaboration and management. In order to match the requirements for document merging, simultaneous viewing, and document element selection, document drafts are versioned and stored in a central repository 800. Document owners view and edit documents in the central repository 800. Upon approval, the application creates an updated source document. The source documents are maintained in a central portal repository. The EDGAR filing (discussed below), printing, distribution, and eCommerce applications 802 run from the central repository. In one implementation, using document translators 804, the documents stored in the repository 800 and in the central repository are XML documents that can be viewed and revised using word processing applications.

F. Examples of Document Management Processes

By way of example, the document management portal 110 may be used by a client who signs up to become user of the document management portal 110. An administrator generates a client profile and the document management portal 110 generates and sends an email to the client welcoming the client as a newest member of the portal's solutions for real time document drafting, collaboration, printing, filing and distribution work. The administrator issues the client a username (e.g., an email address retrieved from the profile) and a passcode (e.g. a random 6 digit alpha numeric code initially assigned) and invites the client (by name retrieved from the client profile) to go to the portal's website (e.g., www.libac.com) and begin a project.

A client user (project lead or his/her assistant) logs onto the Internet and enters the pre-assigned username and passcode at the home page of the document management portal 110. At an initial login, the system gives the user a chance to change the supplied passcode to their own confidential code which will be used from that point forward when they log into the system. Upon login, the client user sees all projects he/she has previously been assigned to that are currently live. The client user can also open a new project by clicking on a “Client/Project Setup” button or hyperlink. If the client user opens a new project, the client user fills in appropriate fields and attaches the document(s) to be processed (e.g., converted). However, those skilled in the art will recognize that the embodiments described herein can be practiced without one or more of the specific details, or with other methods, components, and materials, including Two-Factor Authentication, Biometrics and other industry standard security methodologies.

The client would then assign WGM's (by filling out profiles for each WGM if they are new or by using drop down menu to choose from an existing WGM list previously entered) to the project and issue rights for this given project after which the system would generate and send an email to each WGM notifying them there is a new project for them to work on. If the user opens an existing project they were previously assigned to, they can begin working on the project document by clicking on the document icon or project title. Each member of the working group is assigned their own copy of the initial document(s) related to the project (e.g., held in the repository 800 shown in FIG. 8) uploaded by the project lead or authorized assistant (held in a central repository such as the corporate repository 208 shown in FIG. 2). In another embodiment, each member who is assigned the role of “Editor” uploads draft copies of the document to the central repository. Each member of the working group is then notified by a system generated email that version 1, draft cycle 00 is ready for their review.

The document management portal 110 enables a WGM to edit within a web browser and/or allows the WGM to checkout a document, make edits on their computer in a word processor or spreadsheet (for financials) of their choice, and enables the WGM to later check in the document version from which the system would update a new draft cycle number (from 00 to 01 etc.). The system identifies differences between the versions created by different WGMs. The differences may include, for example, different words or punctuation in a sentence, added or deleted sentences in a paragraph, new or deleted paragraphs in a section, and/or new or deleted sections.

The document management portal 110 provides the working group team leader or document owner (e.g., a project lead or an authorized assistant) a view of each different version by sentence, paragraph, or section. Each difference is presented sequentially by document section. This view allows the team leader or document owner to select one of the versions or to create (using normal word processing tools such as new entry, cut, copy, and paste) a new version. The selected or created version is saved as either a new draft within a version (e.g., “Save as Draft” command, which maintains the current version number and updates the draft number by one number larger i.e. 1.0 to 1.1, 1.2 . . . ) or saved as a new version (e.g., “Save as Final” command which updates version by one number i.e. 1.0 to 2.0, 3.0 . . . etc. and returns draft cycle numbers to 0.0) and is saved back into the document repository). The document management portal retains all original and subsequent versions and draft cycles so that the leader can, if needed or desired, re-do the document review operation with other document versions and or draft cycles (e.g., interim version updates).

Additional features of the system may include, for example, a multi-tiered versioning system that updates the draft number of a draft when it is saved or posted back into the document repository, and updates the version number of a document when it is merged and saved back into the document repository. Another feature includes a document repository that is accessed via the Internet or an Intranet. The repository maintains a record of what documents and subsections are checked out to which team members. The repository includes current and previous document drafts and versions. Another feature includes full text search of documents in the repository.

By way of another example, a project manager may use the content management sub-module 222 for document creation and completion. The project manager may begin by searching the global repository 206 or the corporate document repository 208 for a source document. The project manager configures a project workflow and the project document repository 210 for the particular project. The project manager makes the entire document available or divides the document into subsections and assigns draft and revision tasks to team members. Team members check-out documents or subsections, create drafts, and check-in final drafts. Reviewers view multiple drafts for a given document or subsection and accept, reject or modify changes to create the final draft master. The project manager updates the final draft master changes into a core master. This creates a new document version. The system automatically notifies WGMs via email that a new version exists and is ready for their review. The process repeats until a final core master version is achieved.

G. Document Production

In one embodiment, the document management portal 110 interacts with the internal information and workflow management systems of many regional and national printing companies that accept electronic submissions and produce financial documents. The document production module 214 allows users to specify production needs for one or multiple printing companies. If a printing company is not specified, the document production module 214 gives a lowest cost among all providers listed. The document production module 214 includes pricing information (based on quantity, location and timeline) for these printing companies. The printing companies can use the document production module 214 to update pricing lists and printing schedule information for each plant location.

By way of illustration, and not by limitation, in an example workflow using the document production module 214, “XYZ Corp.” desires to produce 500 document copies for New York City, 200 copies for San Francisco, and 50 copies for Denver. XYZ Corp. uses the document production module 214 to select printers in New York City, San Francisco, and Denver that meet their price and timeline requirements or the lowest cost site for printing all 750 sets of the document at one location from which shippers would deliver to the respective cities in the distribution list (whichever option the client chooses because sometimes price will be the driver and sometimes price is less of a concern and time of delivery is most critical).

XYZ Corp. uses the document production module 214 to transmit a soft, print-ready copy of the document to the New York City, San Francisco, and Denver printers or one soft copy to the lowest cost plant if cost is the driver and timelines can still be met using third party shippers. The printer(s) use the document production module 214 to confirm the receipt and completion of the documents. XYZ Corp. uses the document distribution module 214 to specify and manage the distribution lists of the documents from the printer(s).

H. Document Distribution

The document distribution module 216 includes functionality that allows users to manage the distribution of financial documents. With the document distribution module 216, users specify the quantity, destination, and shipping method for the financial documents. The document distribution module 216 allows the drop shipping of documents directly from alliance printing facilities and includes links to the tracking systems of common, national and international shippers (such as FedEx, UPS, or U.S. Mail).

I. User Interface

The user interface 218 lets users select from the above modules. Thereafter, the user interface 218 lets users select both process steps and documents. Additionally, the user interface 218 lets each user create a customized “skin” to personalize the interface.

At a homepage for the document management portal 110, users can purchase the services available through the document management portal 110 and set-up their accounts on a project by project basis. In one embodiment, subscribing clients purchase license agreements by speaking with sales representatives.

J. Application Interfaces

The printing and distribution modules 220 include custom API and Web Services that users can use to interface these modules with their billing applications. The user interface 218, the conversion and filing module 213, and the printing and distribution modules 220 include interfaces to an online credit card processing application so that users can purchase the use of services offered through the document management portal 110 and also make on-line payments for filing, printing and distribution requirements (which are third party alliances).

III. Document Conversion and Filing

Referring again to FIG. 1 and FIG. 2, as discussed above, the user system 112 according to one embodiment creates financial or other documents for submission to the electronic filing system 116. Depending on the regulatory requirements of each user 112, the users 112 can use the document management portal 110 to complete an on-line filing of financial documents directly to the SEC or other regulatory agencies. As shown in FIG. 2, the document management portal 110 includes a conversion and filing module 213 that converts financial documents into the format required for on-line SEC filings using the EDGAR system.

A. Example Conversion and Filing Methods

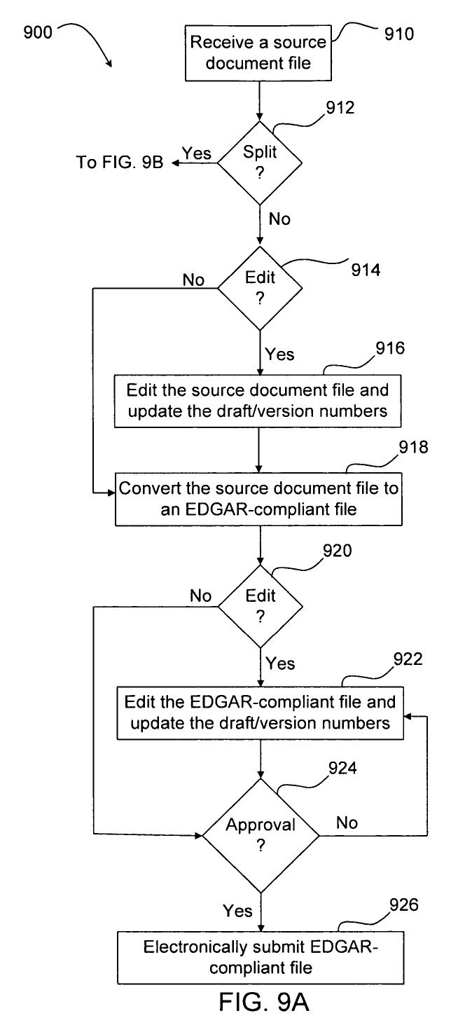

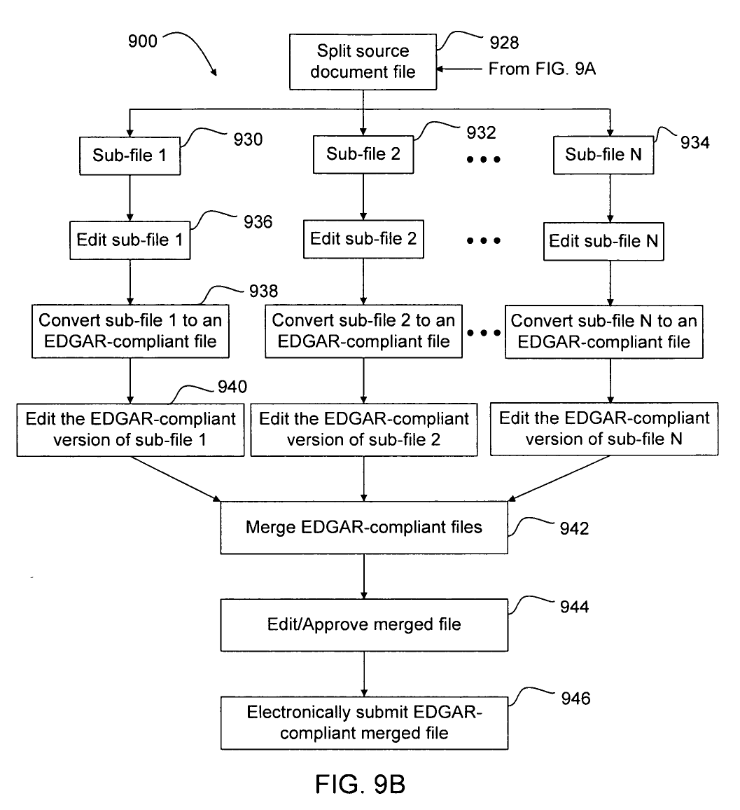

FIGS. 9A-9B are flow charts of a process 900 for converting documents to an EDGAR-compliant format according to one embodiment. The process 900 includes receiving 910 a source document file. As discussed above, the source document file may be a financial document created in a word processor or other application (e.g., a spreadsheet application) selected by a user. The process 900 then determines 912 whether to split the source document file, as discussed above. If the user decides to split the source document file, the process proceeds to FIG. 9B.

If the user decides not the split the source document file, the process 900 determines 914 whether the user or a group of users desires to make edits to the source document file. If the user or users decide to make changes to the source document file, the process 900 allows edits 916 to the source document file and updates the draft and/or version numbers of the source document file. As discussed above, in one embodiment, document translators convert the source document file to and from an XML format so the users can review and edit the source document file using a word processing application of their choice.

The process 900 also converts 918 the source document file to an EDGAR-compliant file. The source document file is converted to either EDGAR-compliant HTML or ASCII text. In one embodiment, the conversion and filing module 213 shown in FIG. 2 uses templates to apply style and format rules to the source document file. The conversion and filing module 213 includes pre-defined templates and the user can modify a previously created template and save it under a new name. The source document file is placed in a processing queue, together with a selected template, for conversion by the conversion and filing module 213. Output files (in an EDGAR-compliant format) are placed, for example, in the user's web folder and an automated email notification is sent to the user. An error log displays any error messages encountered during the conversion process. In one embodiment, the number of converted documents and the total page count per converted document are recorded for billing purposes.

In one embodiment, the conversion templates provide features such as text alignment (e.g., left, right, justify) or use source file alignment, preservation of paragraph indentation (e.g., the user can select whether to not to preserve indentations), and table formatting options. The table formatting options can be applied, for example, to a whole table, a header row, a last row, a left column, a right column, odd rows, even rows, odd columns, and/or even columns.

Table formatting options may also include, for example, font editing (e.g., name, size, color, bold, italic, or underline), cell editing (e.g., background color, border color, border width, horizontal alignment, or vertical alignment), table width (e.g., use source table width, fixed width as percent or inches, or auto-fit), row striping, wrap text within cells, cell border adjustments (e.g., right, left, top, bottom, width, or color), and <R> tagging options. Such <R> tagging options at generation time include, for example, generating <R> tags based on revisions/blackline in the source document file, showing a final revision and deleting old revisions, showing the final revision and keeping old revisions hidden in the source, and showing revision markup as is in the original document.

The conversion templates may also, for example, generate a hyperlinked table of contents (where none exists in the source document file), regenerate a hyperlinked table of contents (where one exists in the source document file), maintain pagination of the source document file including both hard and soft page breaks and/or remove all page breaks, display page breaks in some way, generate hyperlinked footnote tags, and fix page widths based on the source document file or allow full browser page width.

In one embodiment, the conversion templates format hanging text so as to right-align numbers. Hanging text is specific punctuation that follows a number such as a closing parenthesis, percent sign, footnote character or number. When converting to HTML or ASCII, it may be desirable that such punctuation characters hang to the right of the last character. For example, Table 1 below shows numbers right aligned with punctuation characters within the cells of the table.

TABLE 1
(123.45)%
123.45%
23.45⁽¹⁾

To convert Table 1, the conversion and filing module 213 right aligns the numbers, recognizes hanging punctuation characters, places the hanging punctuation characters in a next cell (e.g., to the right) in the corresponding row, and left aligns the hanging punctuation characters. For example, after the conversion process, Table 1 above is converted to look like Table 2 below.

TABLE 2
(123.45)%
123.45%
23.45%⁽¹⁾

The process 900 determines 920 whether the user or users desire to make edits to the EDGAR-compliant file. If the user or users decide to make changes to the EDGAR-compliant file, the process 900 allows edits 922 to the EDGAR-compliant file and updates the draft and/or version numbers of the EDGAR-compliant file. The conversion and filing module 213 allows users to edit HTML or ASCII files. However, in one embodiment, the conversion and filing module 213 does not permit any changes that would cause the EDGAR system to reject the EDGAR-compliant file.

In one embodiment, the conversion and filing module 213 includes an EDGAR HTML editor module (not shown) configured as a browser plug-in that permits WYSIWYG (what you see is what you get) HTML editing of the conversion process output. The EDGAR HTML editor module allows a user to, for example, insert/delete/edit text, edit text format (e.g., font name, size, color, bold, underline), edit paragraph alignment (e.g., left, right, justify), add/edit hyperlinks and anchors (internal bookmarks), add/edit/delete images, apply pre-defined styles to elements (including tables), add/edit/delete tables, add/edit/delete table rows or columns, select and format tables, select and format adjoining table cells, split cells, merge cells, select column(s) or row(s) and edit cell properties for all selected cells, select alternate rows and edit cell properties for all selected cells (including applying shading or removing shading), select table and edit cell properties for all selected cells, select column(s) and apply right-align/center-align/left-align, adjust column width (single column), toggle between view revisions (blackline) or hide revisions (view revision displays insertions as underlined and deletions with strikethrough), toggle track changes (when enabled, track changes inserts <R></R> tags for all edits to the file), toggle to display/hide “show source” (where the source code is displayed in a separate window below the WYSIWYG content), and make a change in the HTML Source code and display the result in the WYSIWYG content. Other HTML editing functions will occur to those skilled in the art.

The process 900 further includes querying 924 whether converted EDGAR-compliant file has been approved for filing. If the EDGAR-compliant file has not been approved, more edits may be made to the file. If the EDGAR-compliant file is approved, the process 900 electronically submits 926 the EDGAR-compliant file to the EDGAR system.

In one embodiment, the conversion and filing module 213 uses EDGAR-compliant XFDL forms with templates provided by the SEC to test file and live file the EDGAR compliant file. In one embodiment, the conversion and filing module 213 also handles payment of EDGAR fees. The forms provide validated header information required for submission of documents using the EDGAR system. The conversion and filing module 213 provides users with access to the EDGAR forms in a web browser (e.g., as a selection list to select the appropriate form) with the ability to select files to include with a selected form.

The templates and forms may include, for example, various 1933 Securities Act registration statements, various investment company submission types, annual/quarterly/periodic reports, 1934 Securities Exchange Act proxy materials and information statements filed pursuant to Section 14, various investment company submission types, 13F quarterly reports, 1934 Securities and Exchange Act registration statements, submission types for business development companies, Company Act registration statements, registration of securities by certain investment companies pursuant to Rule 24f-2, Williams Act submission types, submissions pursuant to the Trust Indenture Act, other submissions pursuant to the Trust Indenture Act, registration statements for foreign issuers, prospectuses filed pursuant to Rule 424, miscellaneous 1933 Securities Act submission types, Rule 144 submission types, development bank submission types, and periodic reports for registered investment companies.

The forms may include both required and optional fields and validation routines. The validation routines include a relational validation wherein a change to one field changes other fields to correspond to the new value. Form fields and validation rules may be proscribed by, for example, the SEC. Form requirements include required and optional data fields, data type, and data validation (including relational validation).

The forms are submitted to the appropriate EDGAR web site using the user's CIK and CCC codes associated with the EDGAR system. In one embodiment, the user's CIK and CCC codes are automatically filled in on each form from a user database record. If the codes are unknown to the conversion and filing module 213, the user is prompted to enter the codes for storage in the user database for use with subsequent filings. In one embodiment, the user is not shown the CIK and CCC codes on the forms.

Referring to FIG. 9B, if the user decides to split the source document file, the process 900 splits 928 the source document file into a first sub-file 930, a second sub-file 932 and a third sub-file 934. Each of the sub-files 930, 932, 934 can then be assigned to different users, for example, to be independently edited 936 and converted 938 to separate EDGAR-compliant files. Each EDGAR-compliant version can then be edited 940 by the respective assigned users. The process 900 also includes merging 942 the separate EDGAR-compliant sub-files to create an overall EDGAR-compliant file that can be edited/approved 944 and electronically submitted 946, as discussed above.

B. Document Conversion Examples

The following examples are provided for illustrative purposes only, and are not intended to limit the scope of the disclosure. In one example, an authorized client member “controller” of an existing client called “ABC Company” submits a document called “ABC Form 10-K” for conversion without customer service assistance. The controller signs onto the document management portal 110 and uploads a file called “ABC Form 10-K.doc,” version 1.0 to a draft folder corresponding to ABC Company. The controller selects an “EDGAR Conversion” and selects the ABC Form 10-K.doc version 1.0 for conversion (with no splitting of the document).

The conversion and filing module 213 converts the file to EDGAR HTML and puts the converted file in the same folder as the original file. Thus, the controller can view an “ABC Form 10-K.htm” version 1.0 draft file in the folder. The controller can then select an edit icon to open the HTML file with the HTML editor. The controller may make one or more edits to the HTML file. Upon saving the edited HTML file, the conversion and filing module 213 automatically generates “ABC Form 10-K.htm” version 1.1.

The controller may select a create PDF icon to generate an “ABC Form 10-K Proof 1.pdf” file and automatically generate an email that is distributed to other authorized working group members. The email comprises an auto hyperlinked email message on a project that was previously set up for the folder. An authorized user can click on the link and log into the document management portal 110 without any additional effort on the authorized user's part (assuming the authorized has logged in at least once previously).

The client's chief financial officer (CFO) and outside counsel, who are authorized members of the working group for this project, may review the PDF.proof 1.pdf file and suggest a few changes by replying to the email they received. The comments or suggested changes are received by the controller. The controller again opens the file 1.1 in the HTML editor, makes the requested changes, and saves the file. The conversion and filing module 213 automatically generates “ABC Form 10-K.htm” version 1.2 in the draft folder and another email notification is sent with the auto hyperlinked document 1.2 attached. This draft is approved by the CFO and outside counsel. The controller saves the latest HTML file to the controller's desktop and uses an EDGAR link to submit the file to the SEC.

In another example, a reseller assists in filing the documents. In this example, an authorized client member “controller” of an existing client called “ABC Company” submits a document called “ABC Form 10-K” for conversion, editing, and filing to be completed by the reseller. In this example, the reseller has three customer service editors assigned to the project.

After signing into the document management portal 110, the controller submits two files, “ABC Form 10-K.doc” and “Appendix 1.doc,” using an online work request form. The document management portal 110 sends an email to a customer service account manager and to the reseller's general manager and sales account representative notifying them of the EDGAR request to “start work immediately.”

The account manager signs into the document management portal 110, views the ABC Form 10-K file, and decides to split the file for three simultaneous edits. The account manager clicks the EDGAR Conversion link and enters three as the number of workfiles to create. The account manager assigns 25 pages to part 1, 25 pages to part 2, and the balance to part 3. The account manager then submits the three files for EDGAR conversion.

The conversion and filing module 213 splits the file ABC Form 10-K.doc into three parts, creates a sub-folder for the work files, and saves the three files as “ABC Form 10-K_Edit_1.doc” draft version 1.0, “ABC Form 10-K_Edit_{—}2.doc” draft version 1.0, and “ABC Form 10-K_Edit_3.doc” draft version 1.0 in the subfolder. The conversion and filing module 213 converts each workfile into HTML and saves the three HTML files to the same folder, with the same file name except the suffix is “htm.”

The account manager assigns an editor to each of the three files. A first editor signs into the document management portal 110 and opens the folder containing the workfiles. The first editor opens the HTML file assigned and decides to make some Word edits and re-convert the file. The first editor opens ABC Form 10-K_Edit_1.doc draft version 1.0 in Microsoft Word, makes several changes, and saves the file back to the document management portal 110. The file is automatically saved as draft version 1.1. The first editor clicks the EDGAR Conversion link, selects the workfile to submit (without split), and submits. The conversion and filing module 213 converts the workfile and saves the resulting HTML file back to the draft sub-folder as version 1.2.

The first editor reviews the HTML file and decides to do remaining edits using the HTML editor module. The first editor opens the HTML file, makes edits, and saves the file back to the draft sub-folder where it is automatically saved as version 1.3. When the editing process is completed, the first editor selects an Edit button on the HTML document and modifies a status to “completed.”

A second editor and a third editor perform similar edit processes as the first editor, and mark their respective HTML files as completed. The first editor is notified of the completion of each edit using a folder email notification feature. The first editor selects the EDGAR Conversion link and clicks a Merge link to view a Merge HTML Edits screen. The first editor clicks the button to process the merge. The screen displays the workfiles that will be merged, with the last time stamp, and the status of each of the three HTML workfiles. The conversion and filing module 213 merges the HTML files and writes the merged file back to the parent folder as ABC Form 10-K.htm draft version 2.0, using the parent's document name (with the suffix .htm) and adds the file to the draft database.

Using folder notification, the document management portal 110 sends an email to the client informing them that the proof is ready. The email includes a hyperlink to the HTML file. The client receives the email, clicks the link, and reviews the document. Two corrections are noted and emailed back to the account manager. The account manager forwards the corrections back to the first editor who opens the final document in the HTML editor, makes the changes, and saves the file as version 2.1. The document management portal 110 sends a folder update notification. The client clicks the hyperlink and reviews the proof. The client sends approval. Then, the account manager downloads the file to the account manager's desktop and submits the file with the SEC using the EDGAR system.

C. Example User Interfaces

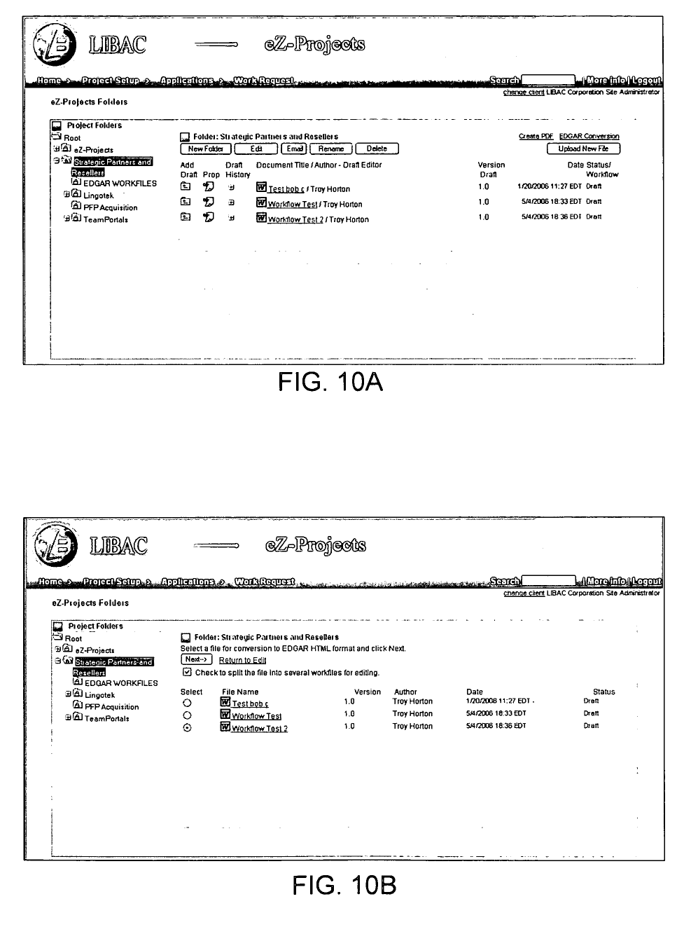

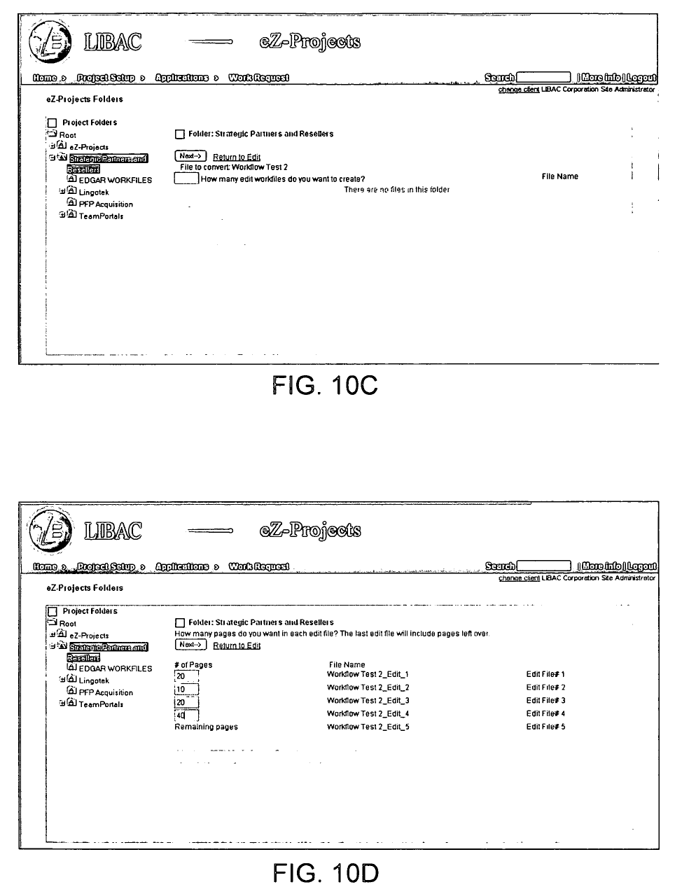

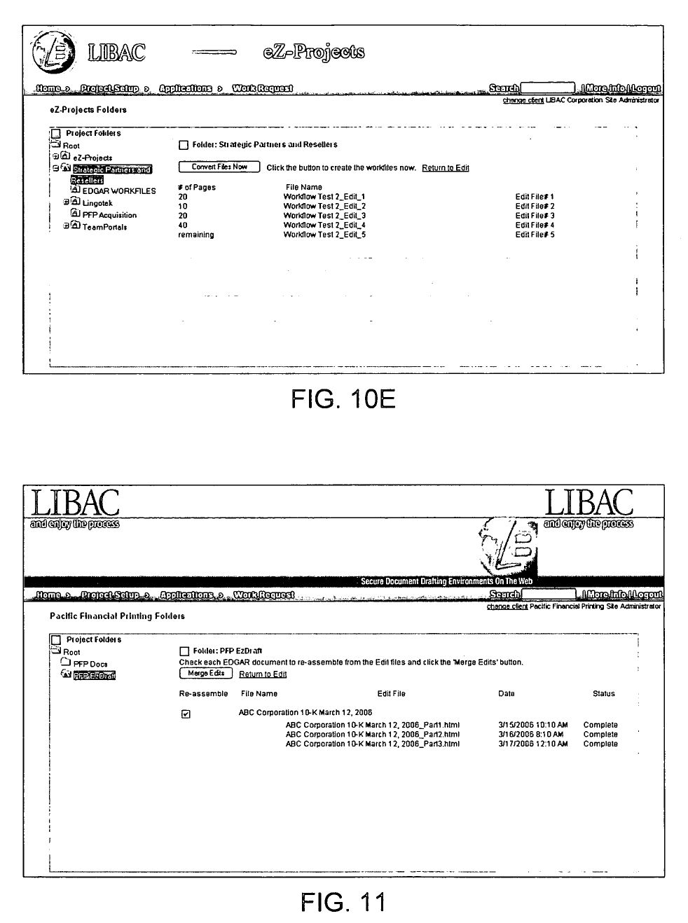

FIGS. 10A-10E are example user interfaces for converting documents for submission to the SEC according to one embodiment. As discussed above, the conversion and filing module 213, according to one embodiment, is available to appropriate members from any draft folder in the document management portal 110. The conversion and filing module 213 is used to convert word processing or other application files to EDGAR-compliant HTML files, which can be edited an approved for submission to the SEC.

The user interface 1010 shown in FIG. 10A lists three files 1012, 1014, 1016 in a draft folder 1018. The user interface 1010 includes an EDGAR Conversion link 1020. As shown in FIG. 10B, a user can select one file 1016 for conversion. The user can also select a check box 1022 to split the file 1016, if desired. If the check box 1022 is selected, a user interface 1024 shown in FIG. 10C is displayed. The user interface 1024 includes a field 1026 that prompts the user for the number of workfiles to create from the split. As shown in FIG. 10D, the user may also define the size of each HTML edit file in number of pages 1028. In this example, the source file “Workflow Test 2” 1016 is split into five edit files 1030. If a file is not being split, a single edit filename is displayed.

A user interface 1032, shown in FIG. 10E, allows the user to confirm how the file 1016 is to be split and to select a convert files now button 1034. Selection of the convert files now button 1034 starts a background process that converts the edit files 1030 to EDGAR-compliant HTML files. The individual EDGAR-compliant HTML files can then be edited, as discussed above.

FIG. 11 is an example user interface 1100 for merging split HTML files 1108 according to one embodiment. The user checks a status 1110 of the separate HTML files 1108. When each file a “complete” status, the user can select a merge edits button 1112 to reassemble the HTML files 1108 into a single HTML document.

IV. Example Work Request User Interfaces

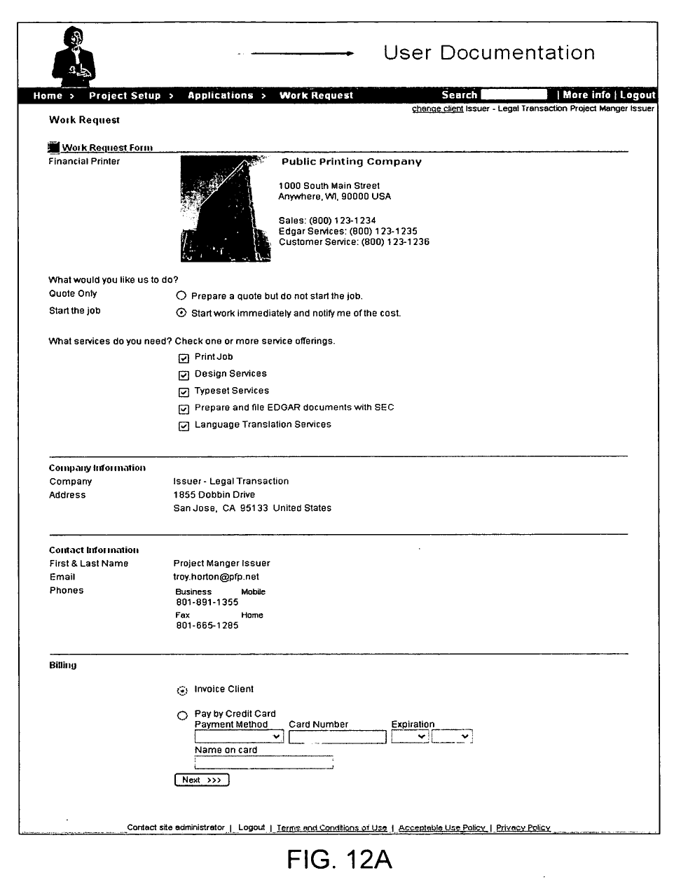

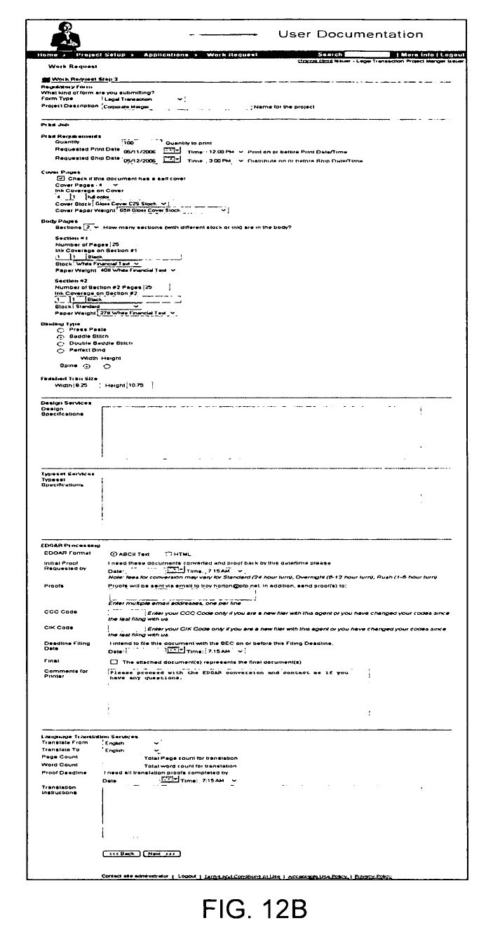

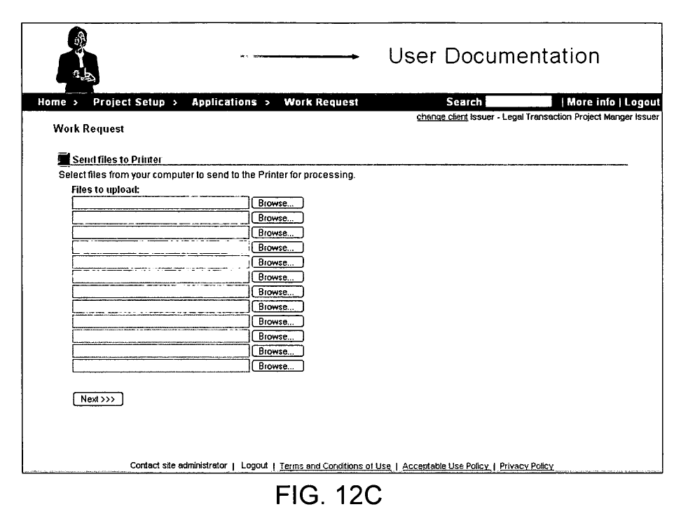

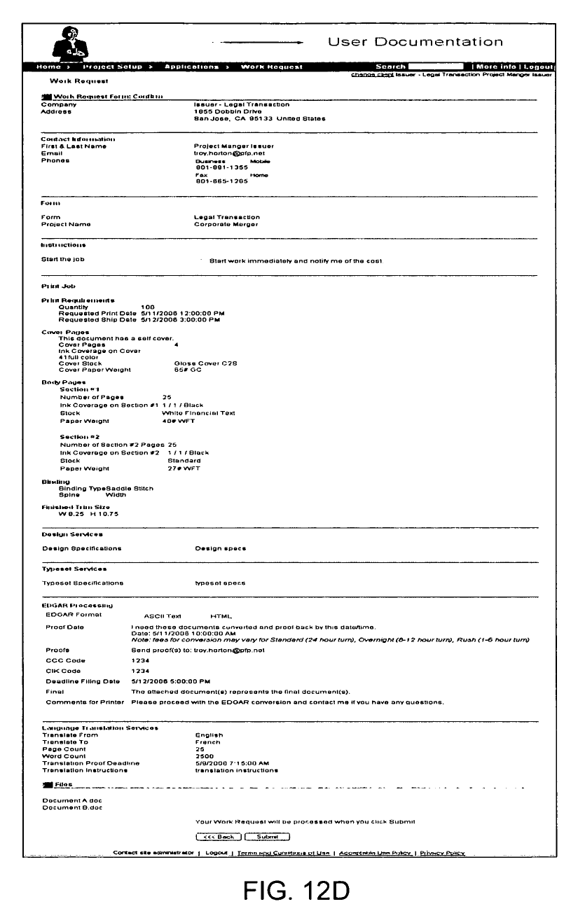

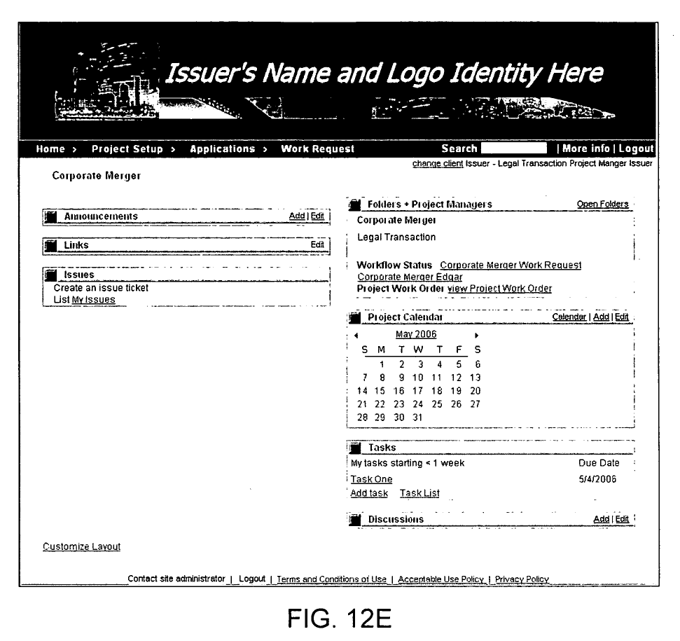

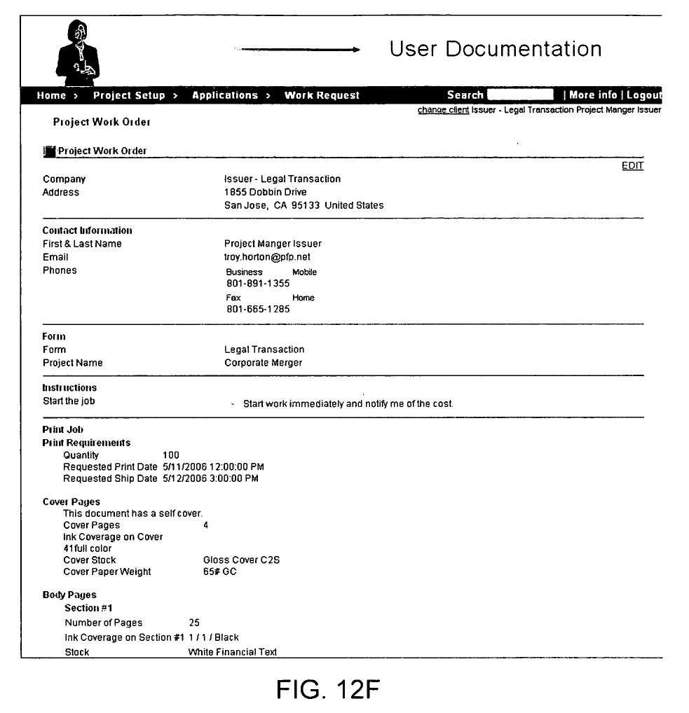

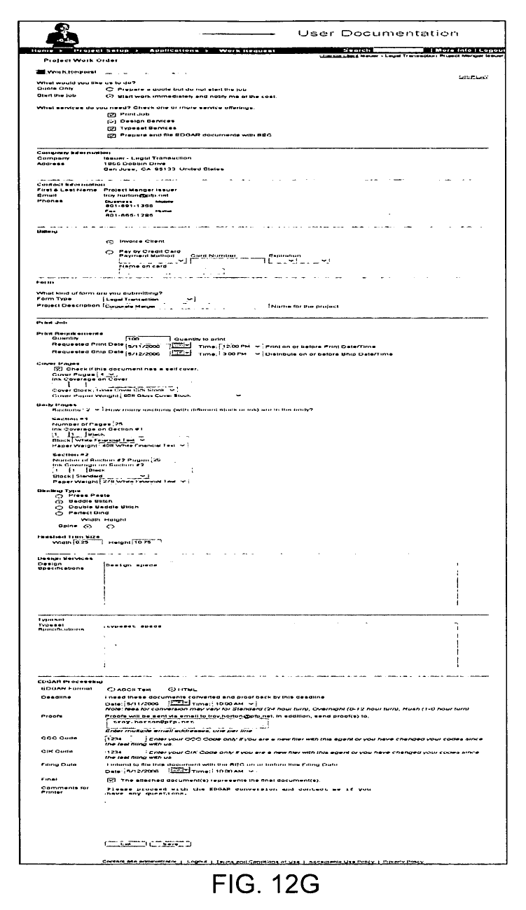

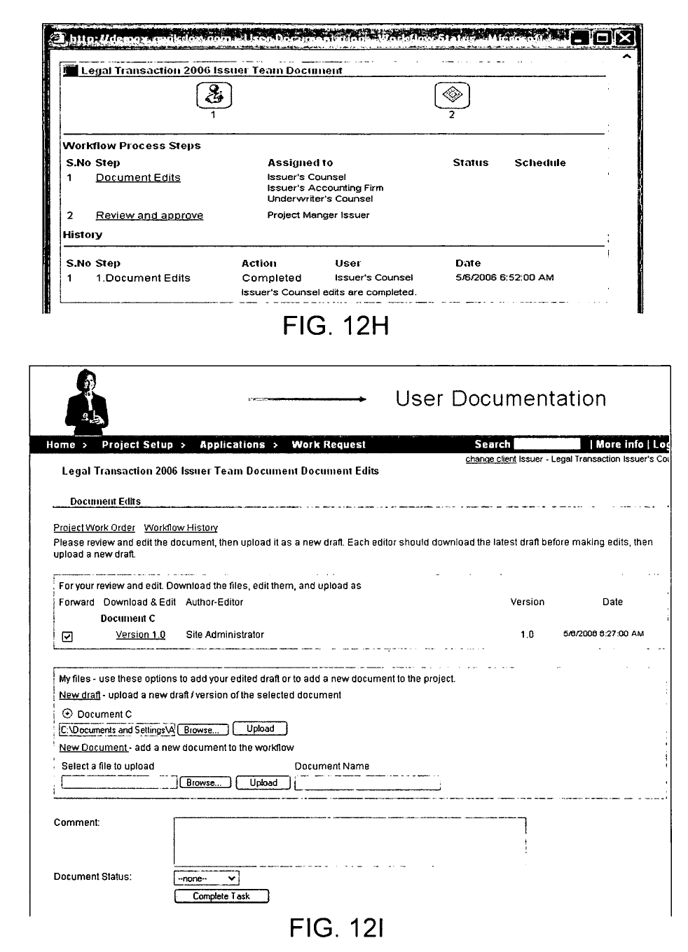

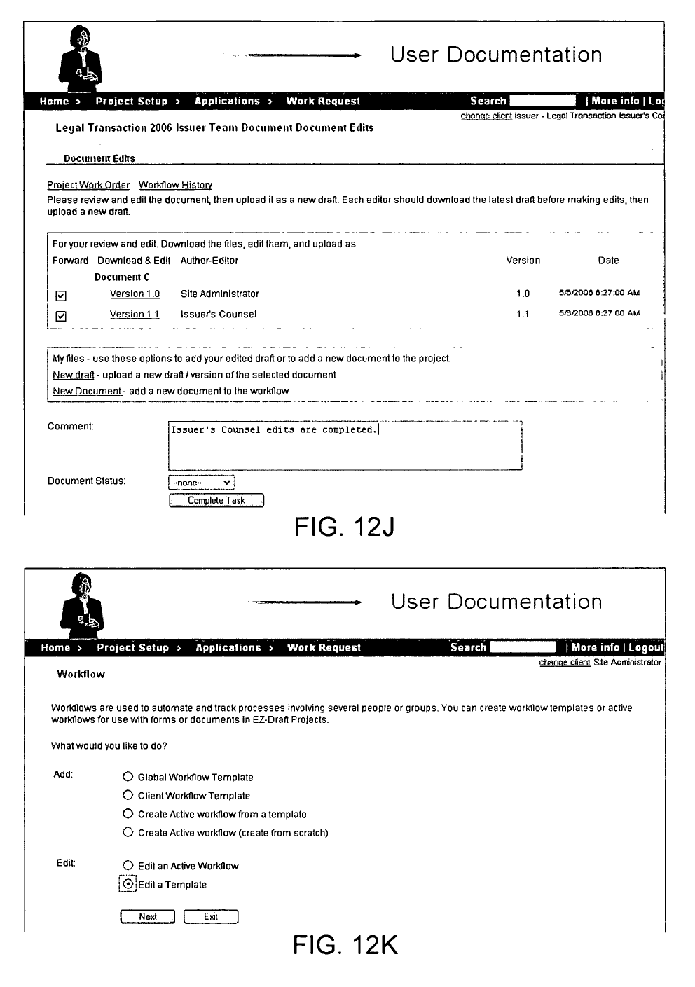

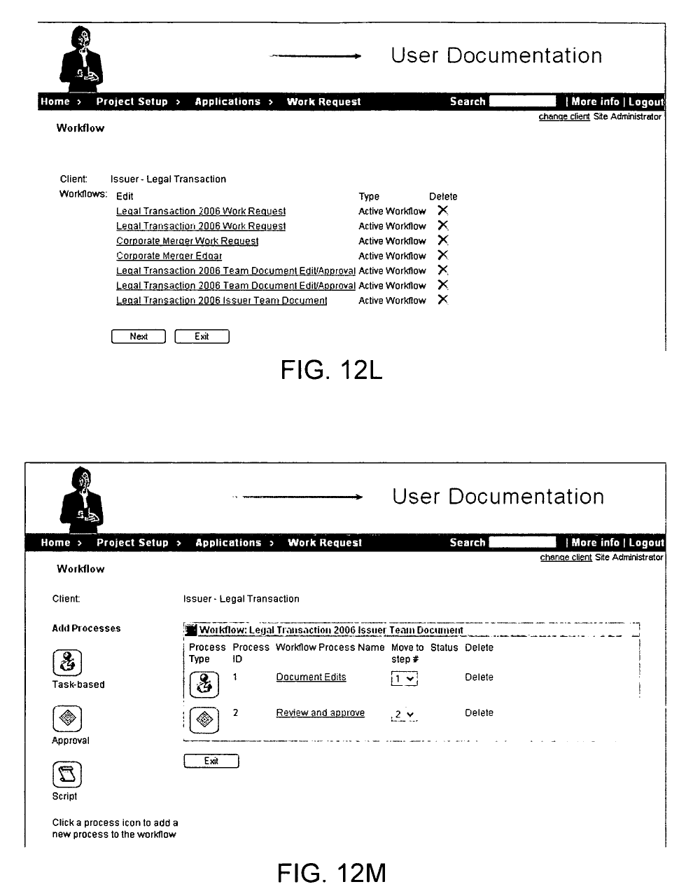

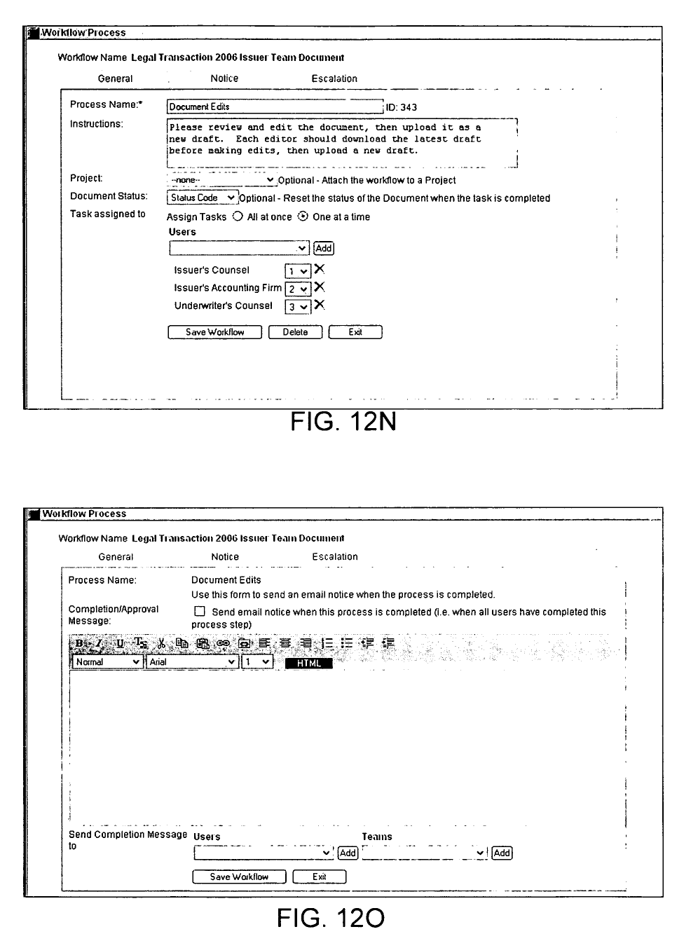

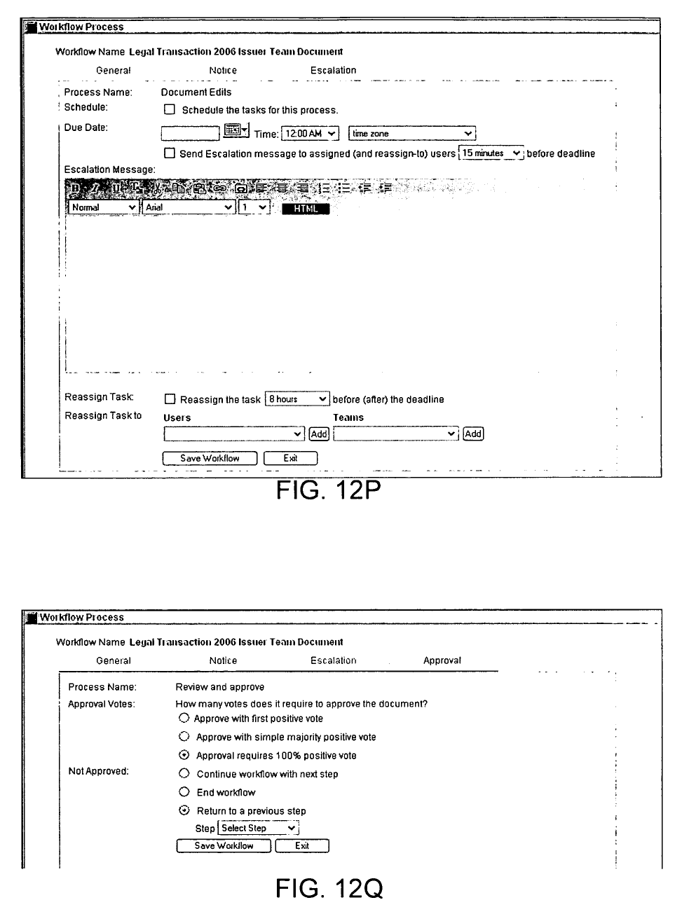

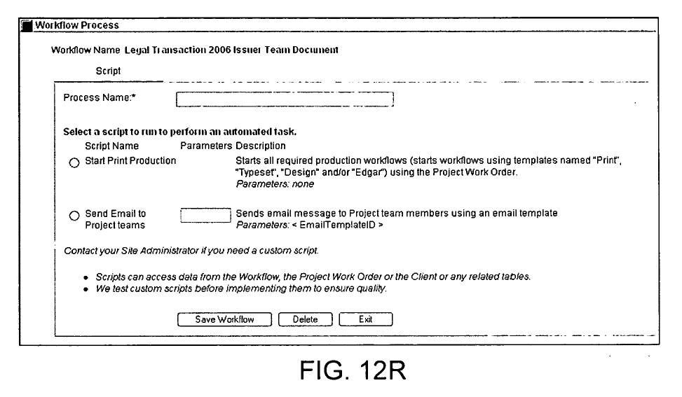

FIGS. 12A-12R are example user interfaces for an online work request system according to one embodiment. An artisan will recognize that the user interfaces shown in FIGS. 12A-12R are an illustrative example of one embodiment, and are not intended to limit the disclosure provided herein. The online work request system is used by, for example, by printing companies who provide this system for their clients. It allows clients to quickly and easily enter requests for quotation or requests to start a project. It captures the information required for the project and it can initiate a workflow process for managing the job.

The user interface showing in FIG. 12A captures general information about the work request, the type of work required, and the company, contact and payment information. A work request form shown in FIG. 12B includes the information required to start any of these five types of jobs: design, typeset, print, EDGAR filing, and language translation. Another work request form illustrated in FIG. 12C enables the client to attach files to the work request. These files are typically source files for the project.

Another work request form shown in FIG. 12D displays a confirmation of the entire work request. If there are any errors the client can go back and correct them before submitting the request. If the work request was created without signing in (that is, if a link is provided to the work request for Internet users to complete the form, and the form has been completed by someone who is not a member), the client and contact information is saved to a customer service (CRM) system as an opportunity, for a salesperson to process. The salesperson can follow up with the prospect and, if the job is accepted, the work request can be converted to a project. In this case, a new client will be added, and a new member will be created. Then the project will be created and the files loaded into the project folders.

On the other hand, if the work request was submitted by a member (signed in), they will have selected a client before creating the work request. So the client and member are already in the system. In this case, if they have requested the printer to “start work immediately,” the system will automatically create a project with two portal pages (a project “home” page and a project “folders” page). It will create a folder and load the files into the folder.

When submitted, the printer is notified of the new work request. An email message is sent to the email address or email distribution list, established for the “sales email” account (in site messages). If the work request includes EDGAR processing, an email message is sent to the email address or email distribution list, established for the “EDGAR email” account (in site messages). For both Site Messages, multiple email accounts can be entered separated by a semi-colon (;). If a workflow template named “WORK REQUEST” exists (either a global or a client template), it will be copied and the first task will be started. If the work request includes EDGAR processing and a workflow template named “EDGAR” exists (either a global or client template), it will be copied and the first task started.

As shown in FIG. 12E, if a project was created from a work request, the project home page typically displays project information in a viewer (folders+project managers). FIG. 12F is a project work order display that includes all information received from the client on the client's work request. Authorized members can click the EDIT link (upper right corner of the display) to make changes to the work order. As shown in FIG. 12G, the project work order may be edited if required to enter changes requested by the client or changes required by the printer. All input fields can be edited except for the client and member information.

FIG. 12H shows a workflow status display that provides visibility to all of the process steps in the workflow, to the status of the workflow and it includes the history of activity for the workflow. For a “step,” a workflow process can be edited by members having the “maintainworkflow” security right, only if the process has not completed. A process is completed only when all of the assigned tasks for the process have completed. For a “history,” the history displays each task completion for the workflow, including member comments and approval votes.

FIG. 12I shows a workflow task screen used to complete the task assigned by the workflow system. Members can open the workflow task screen either by clicking on a task assigned to them (in a portal viewer) or by clicking the document workflow task icon in a project folder. A link to the project work order provides the user with access to information about the project. The link to workflow history provides access to all previous activity on the workflow including comments of authors, editors and reviewers. For a “document list,” a workflow task may have multiple associated documents. In some cases the user may not want to forward all of those documents to the next workflow activity. The forward checkbox permits the user to select the documents to be sent to the next step in the workflow process. Only the documents checked are sent to the next step. A user clicks “new draft” if the user has made edits or changes to one of the documents listed in the document list. The user may then select and upload the file with the changes.

Occasionally, the user may want to add a new document to the workflow. To do this, the user clicks the “new document” link, selects the file, and provides a document name. The new document will be uploaded to a draft folder and added to the document list for the next workflow step. The user can add comments regarding the document(s). The comments are added to the workflow history to be read and reviewed by document authors, editors and/or reviewers. The “document status” resets the status of the document if needed. The new status will display for the document in the folder.

As shown in FIG. 12J, after uploading a new draft of a document using the workflow task screen, the screen is refreshed and now displays the user's new file plus any previous files managed by the workflow. Typically, if the user has made changes to the previous draft of a document, the only file the user will want to check is the new draft. The previous draft has been superseded by the new draft, and the next person to work with the document will only want to see the latest version.

As shown in FIG. 12K, the system supports three types of workflows. Two types are templates, which are copied to create an active (or instantiated) workflow for a project. The templates are global and client. Defined at the site level, a global workflow can be used by any client on any project. Global workflows (because they are not associated with any client) can only have members who are “employees” assigned to workflow tasks. The user security right “adminWorkflow” is required for a user to work with global templates. Defined by a client, the client workflow can only be used on projects for the given client. Client members and teams can be assigned tasks.

The active workflow is an instance of a workflow that is real. That is, it has users assigned to tasks and (if needed) dates and times assigned to task deadlines. An active workflow must be started before it will do anything. Starting an active workflow creates the first set of tasks using the first process. When all tasks and processes are completed, the workflow is completed and no longer displayed. The user can add or edit workflow templates or active workflows, or create an active workflow from a template.

Referring to FIG. 12L, after selecting the type of workflow the user wants to edit, and selecting a Client to work with, the system displays the list of workflows that match the user's criteria (type of workflow, and client). The client clicks the workflow name to edit the workflow processes.

Referring to FIG. 12M, a user can add or edit workflow processes. A task-based process is used to assign and track tasks assigned to users. A task may involve creating or editing a document, verifying information, or any other human task. Each process can create multiple tasks, e.g., one task for each assigned user. Tasks can be assigned by team or by user. Task assignments may be one-at-a-time or all-at-once. One-at-a-time tasks are assigned to one person at a time and only when the first person is completed will the task be assigned to the next person.

An approval process is used to assign approval tasks to users. The process may assign the approval task to users or teams, and approvals may be one-at-a-time or all-at-once. Each person assigned an approval task can vote “yes” or “no.” If multiple documents are associated with the task, they can vote “yes” or “no” on each document. Only if all documents are approved is the task approved. When creating an approval process, the user can establish the rules for determining if the process is approved. It can be approved on the first positive vote, or when a simple majority of “yes” votes is received, or it may require 100% approval.

A script process is an automated system task, such as sending an email message, updating data, or creating and starting other workflows. Scripts are predefined and are selected by the workflow author. Custom scripts may be easily created for your workflow automation needs. Scripts can access data from the workflow, the project work order or the client, or any related tables. Custom scripts are tested before implementing them to ensure that they work properly. The user can contact a site administrator if for custom scripts. The user can click one of the icons on the left of the user interface to add a new process, or click a workflow name to edit an existing process. The user can re-order the processes using the move-to step selector, or delete a process.

Referring to FIG. 12N, an edit workflow “general” tab is used to define the essential information for the process. A process name field is used to enter a brief description of the process. An instructions field is for entering process instructions that are displayed with each assigned task, providing guidance to the user for completing the task. A project field is used, if creating a new workflow, to assign it to a project. It is not required. If the workflow is assigned to a project it is displayed in the project information portal viewer. A document status field updates the document with the selected status when this process is completed. A task assigned to field is for assigning tasks to members.

A task for the process is created for each assigned member. For a global template, only members who are “Employees” are displayed. For client templates or active workflows, all members associated with the client are displayed. A task is created for each assigned member. When the process is initiated either all the tasks are assigned immediately or, if “one at a time” is checked, only one task is created for the first member. When the first task is completed, the task is created for the second member, and so on.

Referring to FIG. 12O, an edit workflow “notice” tab allows the user to establish an email message that will be sent to specified teams or members when the process is completed. The user can select a team or member and click the add button to add them to the email distribution.

Referring to FIG. 12P, an edit workflow “escalation” tab is used to define escalation actions, if required for the process. A schedule field can be checked to require a due date to be scheduled for the process. The due date/time is the deadline for all tasks to be completed for the process. The user can check to require a schedule for a template workflow. The effect of this is that when the template is used to start an active workflow, the user will be required to enter a due date on the active workflow. A due date field is used to set a deadline date/time for the completion of all tasks in the process. If the workflow is a template, the user cannot schedule the process. Only an active workflow can be scheduled. A send escalation message field can be checked to have the system send an email message to both assigned users and reassign-to users. If the user select a lead time for the message, it will be sent X hours/minutes before the deadline. This is a reminder message that the tasks are due by the deadline, and if they are not completed they will be reassigned. A reassign task field is used to select the users and teams to reassign the tasks to. All incomplete tasks for the process will be reassigned to all of the reassign-to users.

Referring to FIG. 12Q, an edit workflow “approval” tab is used to define the business rules for an approval process, and to define what actions will occur if an approval is denied. An approval votes field is used to select the voting rule the user wants to use for approval. If there are multiple people voting, the process will be approved as soon as the voting rule is satisfied. That is, if the user requires a single affirmative vote and there are 5 people voting, the process will be completed when the first person gives an affirmative vote. On the other hand, if the user requires a 100% approval vote, the process is completed (and approval is denied) when one person casts a negative vote. When the process is completed, outstanding voting tasks are automatically canceled. A not approved field is used to select the appropriate action for the workflow, if the process approval result is negative. Typically the appropriate action is to return to a previous step (for example, to return a document to an editor for additional changes).

Referring to FIG. 12R, an edit workflow “script” is used to insert automated processes into the workflow. The user can contact the administrator if the user needs a new automated workflow process. In one embodiment, two scripts are available. A start print production script is designed for a printing company using the system to manage their print production. Following the receipt of a work request, this automated script can be inserted in a workflow to launch up to four separate active workflows. As an example, if the user wants to have each work request reviewed by customer service and approved before starting production, the user could insert this script as a process immediately following the customer service approval process. Once approved, this script will initiate up to four different workflows, depending upon the content of the work request. If the client request includes EDGAR processing, an EDGAR workflow will be initiated, and so on.

IV. Example Work Request User Interfaces

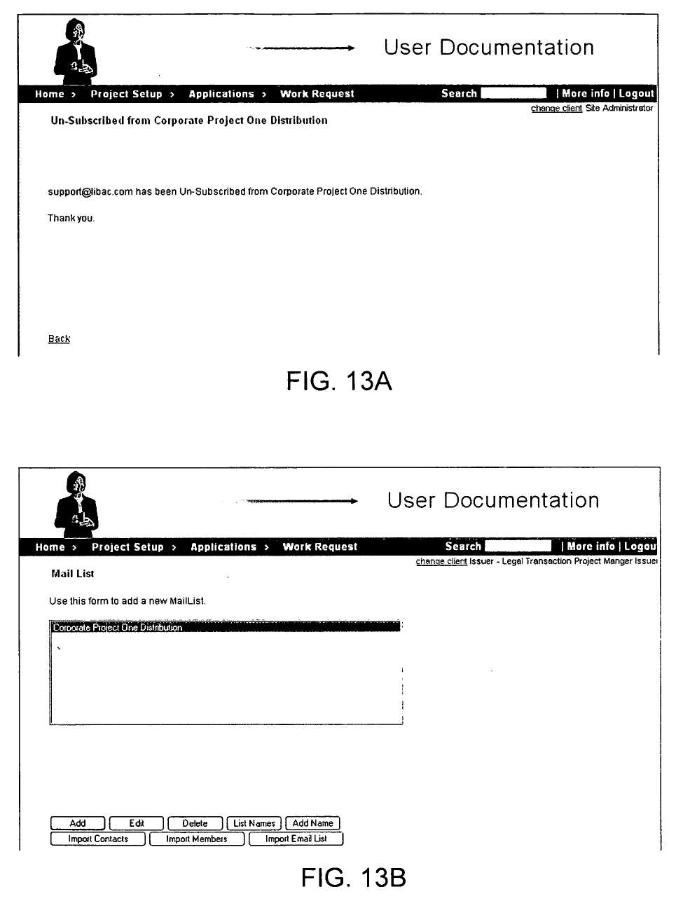

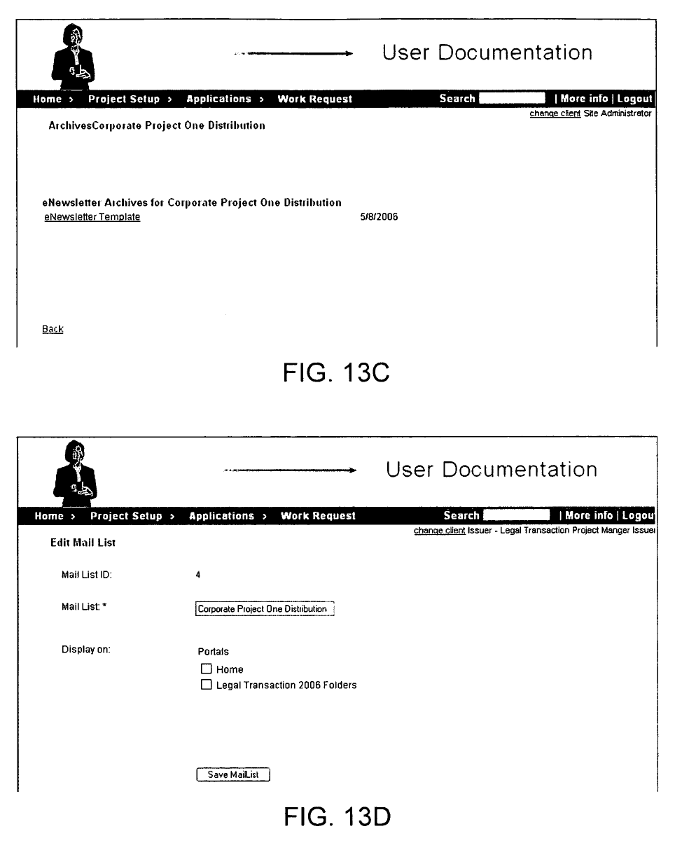

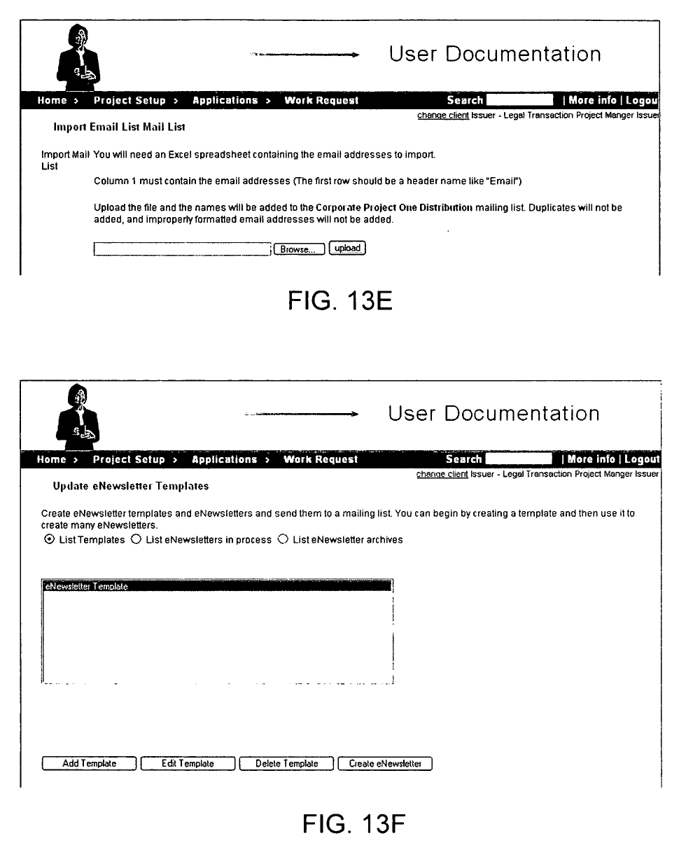

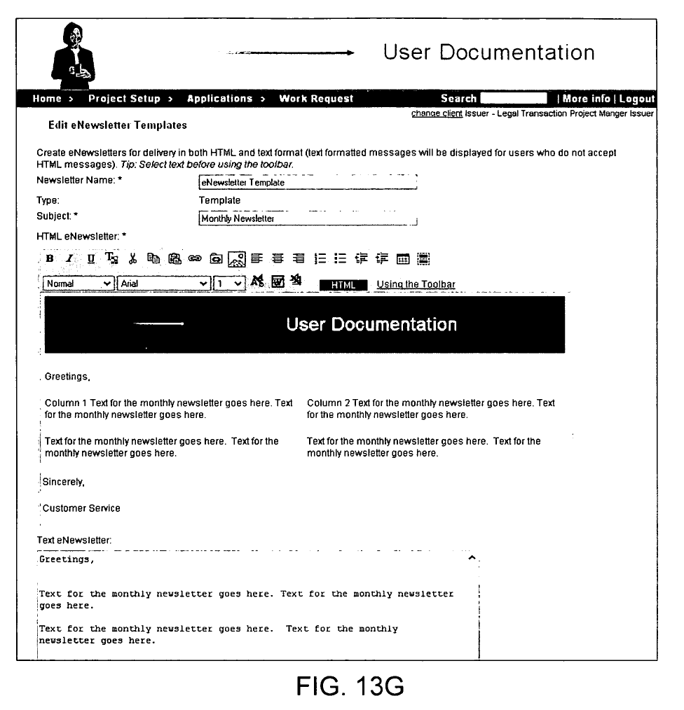

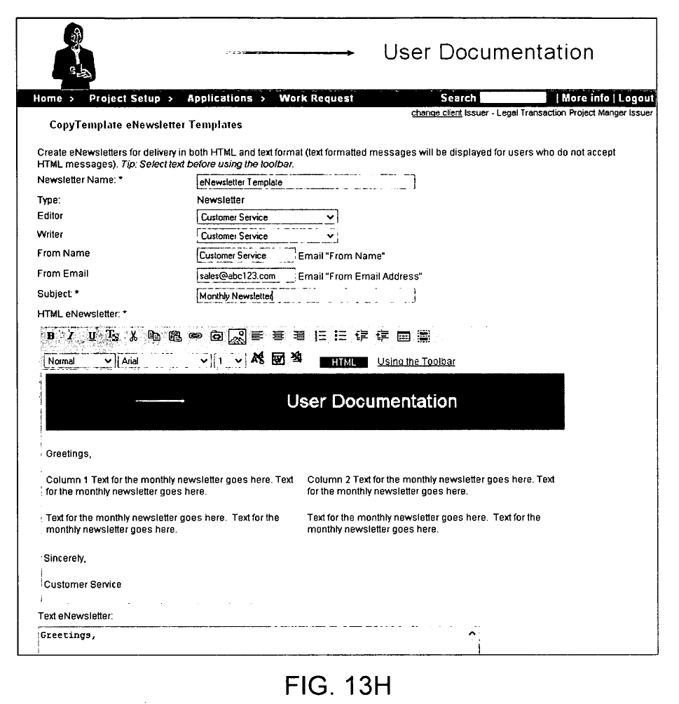

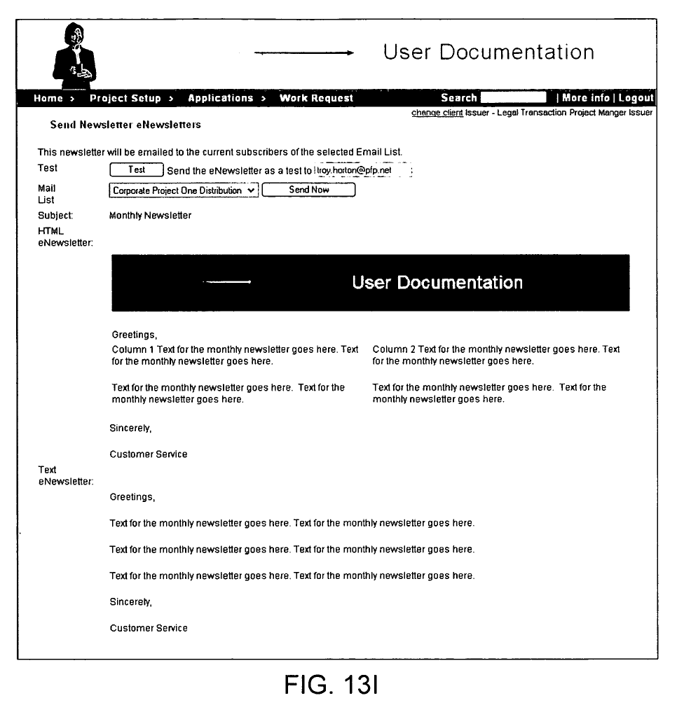

FIGS. 13A-13I are example user interfaces for an online distribution system according to one embodiment. An artisan will recognize that the user interfaces shown in FIGS. 13A-13I are an illustrative example of one embodiment, and are not intended to limit the disclosure provided herein. The online distribution system is used distribute documents to members and other users. Referring to FIG. 13A, a mail list page is displayed after a user selects an option from a portal distribution viewer. The user may be a member (signed in) or a public Internet user (using an Internet web). The mail list screen displays an email subscription confirmation (or an un-subscribe confirmation). Or if the user has selected to view eNewsletter archives, it displays a list of the archives for the selected newsletter.

Referring to FIG. 13B, a mail list is a named list of email addresses and names, used for sending email message blasts to the list. The user can add, edit or delete a list. The user can add or list the names in a list and can import contacts (all contacts), members (all members) or email addresses from a spreadsheet.

Referring to FIG. 13C, members using a portal viewer can access distribution archives. Available archived email messages are listed. The user can click to view an archive.

Referring to FIG. 13D, when creating a mail list, the user provides a name and select any portals where the user wants the list to display. Referring to FIG. 13E, the user can import names into an email list from a spreadsheet. The first column must include the email addresses and the second column is optional. The second column may include the person's name.

Referring to FIG. 13F, the user can edit newsletters using three views. The user can list newsletter templates (a template is a formatted email message that is copied to create a newsletter), or eNewsletters in process, or the user can list archives that are email messages that were previously sent to a mailing list. The user can use the buttons to add a new template, edit or delete a template, copy a template to create a newsletter, edit or delete a newsletter, send a newsletter, or display or delete a newsletter archive.

Referring to FIG. 13G, a user can use an edit newsletter template to create or edit a template for a newsletter. The user may want to create a formatted page with tables and graphics and a certain style. Then the can create each actual newsletter from the template. The user then inserts the new content into the template. The text message is delivered to users who do not accept HTML email.

Referring to FIG. 13H, eNewsletters can be created from templates or without a template. The template is useful for designing a standard newsletter layout with graphics, etc. Then the user can use it to create each newsletter by simply entering new content for each issue. Using templates, the user can add, edit, delete a template or create a newsletter from a template. Using newsletters, the user can add, edit, delete or send a newsletter to a Mailing list. When a newsletter is sent, it automatically moves to the eNewsletter archive.

The publisher of a newsletter is the user that creates the newsletter. They can assign other users as the editor and the writer. The writer only has the ability to edit the content of the newsletter. When completed, they check the newsletter as completed and an email message is sent to the editor. The editor can edit the copy and when complete, another email message is sent to the publisher. The publisher can “re-open for revision” to allow either the writer or the editor to make changes and repeat the cycle. The HTML message is delivered to all subscribers who accept this form of email message. The text message is delivered to those who refuse HTML email (usually for security reasons).

Referring to FIG. 13I, a send newsletter interface is used to send the selected newsletter to an email distribution list. The user clicks test to send a single copy of the newsletter to the specified test email address. A mail list field is used to select an email distribution list. Clicking send now sends the email blast. Both the HTML and the Text messages are displayed for reference.

While specific embodiments and applications of the present invention have been illustrated and described, it is to be understood that the invention is not limited to the precise configuration and components disclosed herein. Various modifications, changes, and variations apparent to those of skill in the art may be made in the arrangement, operation, and details of the methods and systems of the present invention disclosed herein without departing from the spirit and scope of the present invention.

What is claimed is:

1. A method for electronically filing a document, the method comprising:
receiving a first document through a network;
in response to a first command received through the network, converting the first document to a second document having a format compatible with an electronic filing system; and
in response to a second command received through the network, submitting the second document through the network to the electronic filing system.

2. The method of claim 1, wherein submitting the second document to the electronic filing system comprises submitting the second document to the Security Exchange Commission's EDGAR database system.

3. The method of claim 2, wherein converting the first document comprises converting the first document to an EDGAR-compliant format.

4. The method of claim 3, wherein the EDGAR-compliant format comprises an HTML format.

5. The method of claim 1, further comprising converting the first document to a third document having an internal format.

6. The method of claim 5, further comprising receiving one or more revisions to the third document from a user through the network.

7. The method of claim 5, wherein converting the first document to the second document comprises converting the third document to the second document.

8. The method of claim 1, further comprising receiving one or more revisions to the second document from one or more first users through the network.

9. The method of claim 8, further comprising, in response to receiving the one or more revisions:
associating each of the one or more revisions with a different draft number;
notifying one or more additional users of the one or more revisions;
highlighting differences between the second document and the one or more revisions; and
for each individual instance of the one or more revisions, receiving an acceptance or rejection from the second user.

10. The method of claim 9, further comprising including the accepted revisions in a new version of the second document.

11. The method of claim 1, wherein converting the first document to the second document comprises:
splitting the first document into a plurality of sub-documents;
individually converting each of the sub-documents to an EDGAR-compliant format; and
merging the EDGAR-compliant sub-documents into the second document.

12. The method of claim 11, further comprising:
associating each of the sub-documents with a respective user; and
receiving revisions for one or more of the sub-documents from the respective users.

13. A web portal comprising:
a document management module configured to allow a plurality of users to edit a first document;
a conversion module configured to convert the first document to a second document having a format compatible with a remote electronic filing system; and
a filing module configured to submit the second document to the electronic filing system.

14. The web portal of claim 13, wherein the electronic filing system comprises the Security Exchange Commission's EDGAR database system.

15. The web portal of claim 14, wherein the format of the second document is an EDGAR-compliant format.

16. The web portal of claim 14, wherein the EDGAR-compliant format comprises a markup-language format.

17. The web portal of claim 16, further comprising an markup-language editor configured as a browser plug-in that permits markup-language editing of the second document.

18. A system comprising:
means for receiving a financial document through the Internet-means for converting the financial document to an EDGAR-compliant document; and
means for submitting the EDGAR-compliant document to the EDGAR system.

19. The system of claim 18, further comprising means for editing the financial document.

20. The system of claim 18, further comprising means for editing the EDGAR-compliant document.

21. The system of claim 18, further comprising:
means for splitting the financial document into a plurality of sub-documents;
means for editing the sub-documents; and
means for merging the sub-documents into the EDGAR-compliant document.
